(19) United States
(12) Patent Application Publication
(10) Pub. No.: US 2011/0289501 A1
(43) Pub. Date: Nov. 24, 2011

(54) INFORMATION PROCESSING DEVICE, INFORMATION PROCESSING METHOD, AND STORAGE MEDIUM STORING COMPUTER PROGRAM

(75) Inventors: Kouichi YAMASAKI, Kawasaki (JP); Ryuichi MATSUKURA, Kawasaki (JP); Takashi OHNO, Kawasaki (JP)

(73) Assignee: FUJITSU LIMITED, Kawasaki (JP)

(21) Appl. No.: 13/197,307

(22) Filed: Aug. 3, 2011

Related U.S. Application Data
(63) Continuation of application No. PCT/JP2009/053653, filed on Feb. 27, 2009.

(51) Int. Cl. G06F 9/455

(52) U.S. Cl. 718/1

(57) ABSTRACT

An information processing device acquires a device state of an external storage device when a use request is received from a virtual machine. When the device state indicates an allocated state, the allocated state is reported to another virtual machine. When the device state indicates an allocation-enabled state, the external storage device is allocated to the virtual machine. When the device state indicates a release-enabled state, the external storage device is allocated to the virtual machine after unreflected data is processed.

### CROSS-REFERENCE TO RELATED APPLICATION

This application is a continuation application of International PCT Application No. PCT/JP2009/053653 which was filed on Feb. 27, 2009.

### FIELD

The embodiments described below relate to an information processing device, an information processing method, and a computer program for logically dividing a physical resource to operate the physical resource as a plurality of virtual computers.

### BACKGROUND

In recent years, the capability of electronic computers (Personal Computers) for individuals is dramatically improved, and the capability is not fully used in normal applications, such as document creation, email creation, and web browsing. Therefore, a virtualization technology is introduced to the electronic computers to effectively use the remaining power.

A representative example of the virtualization technology includes a thin client system of a virtual PC system. The virtualization technology abstracts a physical resource to divide the physical resource into a plurality of virtual resources and operates virtual machines that are independent from each other. As a result, one virtual machine can be allocated to each of a plurality of end-users by assuming that there are a plurality of physical resources, and a plurality of end-users can use one electronic computer.

The virtualization technology can reduce the number of real devices by integrating resources of a plurality of electronic computers to one electronic computer as virtual resources and can reduce the load of installation location, power consumption, and maintenance. In the virtualization technology, one electronic computer can comprehensively manage information to prevent leakage of confidential information.

In order for each virtual machine to use a physical resource such as a printer device and an external interface and of a USB (Universal Serial Bus) standard or an Ethernet (registered trademark) standard in the virtualization technology, all virtual machines need to share the physical resource, or the physical resource needs to be fixedly allocated to an arbitrary virtual machine.

Conventionally, a computer system that includes an OS switching unit for switching a plurality of operating systems is proposed as a method of allocating a physical resource to virtual machines (for example, Patent Document 1). A device that controls input and output of data to and from a device arranged on a storage device according to a request from an external device is also proposed (for example, Patent Document 2). A system for allocating a resource in a virtual execution environment is also proposed (for example, Patent Document 3).

Patent Document 1: Japanese Patent Laid-Open No. 2000-330806

Patent Document 2: Japanese Patent Laid-Open No. 2006-107257

Patent Document 3: Japanese Patent Laid-Open No. 2007-133854

However, the following problems occur particularly when each virtual machine uses a reader/writer capable of reading and writing data to and from a removable recording medium among the physical resources.

When the reader/writer is shared, an end-user of one virtual machine can access data stored in a recording medium allocated to another virtual machine. Therefore, there is a security problem, such as leakage of confidential information. Thus, the advantage of the virtualization technique described above is lost.

When the reader/writer is fixedly allocated to an arbitrary virtual machine, virtual machines other than the virtual machine allocated to the reader/writer cannot use the reader/writer until the reader/writer is released from the virtual machine allocated to the reader/writer. Therefore, there is a problem that necessary reading and writing of data cannot be quickly performed.

### SUMMARY

A disclosed information processing device is an information processing device that logically divides a physical resource to operate the physical resource as a plurality of virtual computers, the information processing device including: a reader/writer capable of reading and writing data to and from a removable recording medium; a detection unit for detecting a use status of the reader/writer; and an allocation unit for allocating the reader/writer to one of the virtual computers based on the use status detected by the detection unit, wherein the allocated reader/writer is required to read and write data to and from the recording medium in accordance with a request from a virtual computer allocated to the reader/writer.

The disclosed information processing device, information processing method, and computer program can quickly allocate a reader/writer to a virtual machine that needs to read and write data. Furthermore, a state in which data in a recording medium attached to the reader/writer can be browsed from all virtual machines can be avoided, and leakage of confidential information can be prevented.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF THE DRAWINGS

FIG. 1 is a block diagram showing a configuration of an information processing device and a peripheral device in a first embodiment;

FIG. 2 is a functional block diagram of the information processing device in the first embodiment;

FIG. 3 is a diagram showing an example of display of a cache use request screen;

FIG. 4 is a diagram showing an example of display of a device use request screen;

FIG. 5 is a diagram showing an example of format of a device state table;

FIG. 6 is a diagram showing an example of display of a message of device allocation completion;

FIG. 7 is a diagram showing an example of display of a message of device release completion;

FIG. 8 is a diagram showing an example of display of a message of media removal request;

FIG. 9 is a diagram showing an example of display of a message of device usage check;

FIG. 10 is a diagram showing an example of format of a cache management table;

FIG. 11 is a flow chart showing a procedure of a basic device allocation process;

FIG. 12 is a flow chart showing a procedure of an unreflected data process;

FIG. 13 is a flow chart showing a procedure of a basic control process when a recording medium is attached;

FIG. 14 is a flow chart showing the procedure of the basic control process when the recording medium is attached;

FIG. 15 is a flow chart showing a procedure of a basic reading/writing process for the recording medium;

FIG. 16 is a flow chart showing a procedure of a basic device releasing process;

FIG. 17 is a flow chart showing a procedure of a control process when the recording medium is detached;

FIG. 18 is a functional block diagram of an information processing device in a second embodiment;

FIG. 19 is a flow chart showing a procedure of a control process when a recording medium with a predetermined attribute is attached;

FIG. 20 is a flow chart showing the procedure of the control process when the recording medium with the predetermined attribute is attached;

FIG. 21 is a functional block diagram of the information processing device in a third embodiment;

FIG. 22 is a flow chart showing a procedure of a control process when a recording medium with a predetermined attribute is attached;

FIG. 23 is a flow chart showing a procedure of a device allocation process when there are a plurality of external storage devices;

FIG. 24 is a flow chart showing the procedure of the device allocation process when there are a plurality of external storage devices;

FIG. 25 is a functional block diagram of the information processing device in a fourth embodiment;

FIG. 26 is a diagram showing an example of format of a cache storage table;

FIG. 27 is a flow chart showing a procedure of a control process when a plurality of virtual machines share cache data stored in a cache storage unit;

FIG. 28 is a flow chart showing the procedure of the control process when a plurality of virtual machines share the cache data stored in the cache storage unit;

FIG. 29 is a flow chart showing a procedure of a control process when the recording medium is attached;

FIG. 30 is a flow chart showing the procedure of the control process when the recording medium is attached;

FIG. 31 is a flow chart showing a procedure of a deletion process of cache data;

FIG. 32 is a flow chart showing a procedure of an allocation process of the cache data stored in the cache storage unit;

FIG. 33 is a flow chart showing the procedure of the allocation process of the cache data stored in the cache storage unit;

FIG. 34 is a functional block diagram of an information processing device in a fifth embodiment; and

FIG. 35 is a flow chart showing a procedure of a releasing process of the cache data.

### DESCRIPTION OF EMBODIMENTS

### First Embodiment

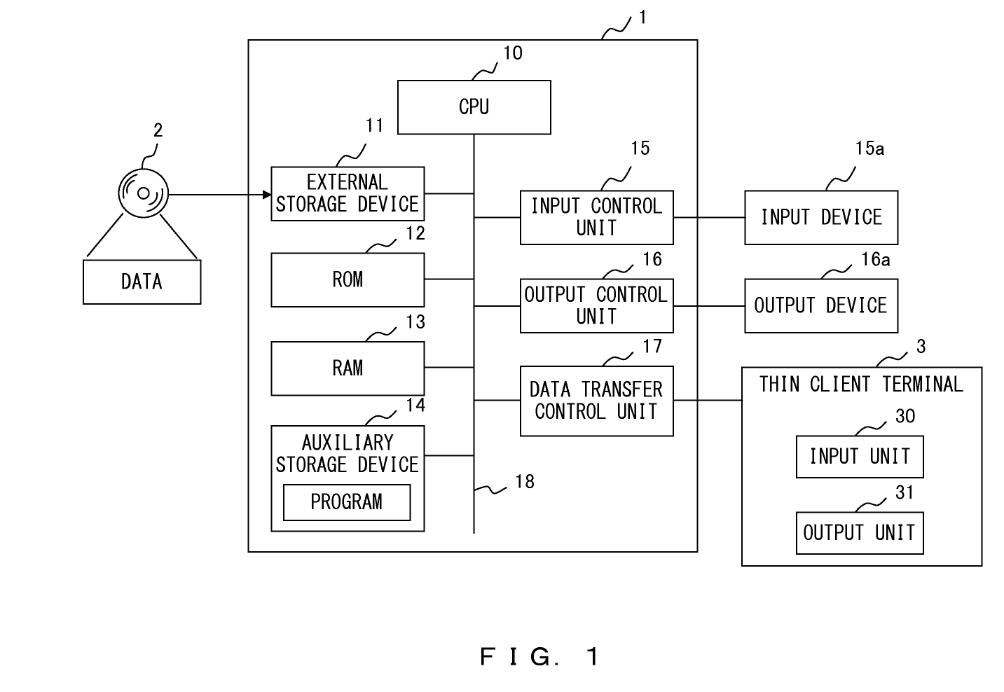

Contents of the disclosed information processing device, information processing method, and computer program will be described based on the drawings illustrating the present embodiment. FIG. 1 is a block diagram showing a configuration of an information processing device and a peripheral device in a first embodiment.

Reference numeral 1 of FIG. 1 denotes an information processing device. Reference numeral 3 of FIG. 1 denotes a thin client terminal. The information processing device 1 is a server device in a thin client system. An example of the server device includes a general electronic computer. The thin client system is a system for causing the thin client terminal 3 to execute minimum necessary processes and causing the information processing device 1 as a server device to integrate the other processes to execute the processes. An example of the thin client system in the present embodiment is a virtual PC system.

The information processing device 1 includes a CPU 10, an external storage device 11, a ROM 12, a RAM 13, an auxiliary storage device 14, an input control unit 15, an output control unit 16, and a data transfer control unit 17. The hardware resources are connected to each other through a bus 18.

The CPU 10 has a virtualization function in accordance with the disclosed computer program. The CPU 10 uses the virtualization function to conceal physical characteristics of the hardware resources from the system, application software, and end-users. The hardware resources are divided into a plurality of logical resources (hereinafter, called “virtual resources”), and the information processing device 1 operates as a plurality of virtual machines. The virtual machines perform various computations based on data received from the thin client terminal 3. The virtual machines output the computation results to the thin client terminal 3.

The external storage device 11 is a reader/writer that reads and writes data to and from the recording medium 2. An example of the reader/writer includes an interface for attaching and detaching a flexible disk drive, an MO drive, a CD-R drive, a magnetic tape drive, a memory card reader/writer, or a USB memory.

The external storage device 11 has an attachment port (not shown), and the recording medium 2 is inserted to the attachment port to attach the recording medium 2. The recording medium 2 is pulled and removed from the attachment port to detach the recording medium 2 from the external storage device 11. The external storage device 11 outputs a notification of the attachment or detachment of the recording medium 2 to the CPU 10.

The recording medium 2 is a removable medium. Examples of the removable medium include a flexible disk, an MO, a CD-R, a magnetic tape, a memory card, and a USB memory. The recording medium 2 stores programs and various data. The programs include an operating system (hereinafter, called “OS”), the disclosed computer program, and other application software.

The external storage device 11 is allocated to the virtual machines as physical resources. The external storage device 11 is exclusively used by the virtual machines.

The external storage device 11 reads data of the recording medium 2 when the recording medium 2 is attached. The information processing device 1 stores the read data in the auxiliary storage device 14 as cache data. The cache data is an image file that stores complete content and structure of a file system of the recording medium 2 in one file. Examples of formats of the image file include an ISO format, a VHD format, and a VFD format.

The information processing device 1 can store the data recorded in the recording medium 2 in the auxiliary storage device 14 while maintaining the file structure. The information processing device 1 abstracts the external storage device 11 to create virtual devices. The information processing device 1 allocates the virtual devices to the virtual machines. The data stored in the recording medium 2 or the saved cache data can be selected to access the virtual devices.

The information processing device 1 can read and write the saved cache data through the virtual devices, just like reading and writing of the data stored in the recording medium 2. The information processing device 1 creates the saved cache data and the virtual devices as virtual resources. The information processing device 1 can quickly release the external storage device 11 from the virtual machines by using the created virtual resources to read and write data.

When the external storage device 11 is in a state in which writing to the recording medium 2 is impossible, the external storage device 11 outputs a notification of occurrence of an access error to the CPU 10.

The ROM 12 is a storage device capable of reading recorded data. The ROM 12 is a semiconductor element that stores a Basic Input/Output System (hereinafter, called “BIOS”) and other firmware.

The RAM 13 temporarily stores data generated by the execution of the CPU 10 or data read from the auxiliary storage device 14. The RAM 13 is a semiconductor, such as an SDRAM (Synchronous DRAM) or an SRAM (Static RAM).

The auxiliary storage device 14 stores data received from the external storage device 11, the ROM 12, the RAM 13, the input control unit 15, or the data transfer control unit 17. The auxiliary storage device 14 is a hard disk drive (HDD) of a magnetic disk recording system or a flash solid state drive (Flash SSD) constituted by a NAND element.

The auxiliary storage device 14 stores data of OSs, the disclosed computer program, and the recording medium 2 as cache data. The OSs include a host OS for controlling the information processing device 1 and a guest OS for controlling the virtual machines.

The input control unit 15 outputs input data received from an input device 15a to the RAM 13 or the auxiliary storage device 14. The input device 15a receives input data inputted by a manager. An example of the input device 15a includes a keyboard and a mouse.

The output control unit 16 outputs output data to an output device 16a. An example of the output device 16a includes a liquid crystal display and a speaker.

The data transfer control unit 17 is an interface for connection with the thin client terminal 3. The data transfer control unit 17 and the thin client terminal 3 are connected to each other through a LAN (Local Area Network). The LAN is realized by a combination of Ethernet and TCP/IP.

The thin client terminal 3 is operated by an end-user and executes information processing. The thin client terminal 3 only includes an input unit 30 and an output unit 31. The thin client terminal 3 depends on the virtual machines for resources other than input and output.

The input unit 30 receives input data inputted by the end-user. The input unit 30 transfers the input data to the data transfer control unit 17. An example of the input unit 30 includes a keyboard and a touch pad.

The output unit 31 receives the data transferred from the data transfer control unit 17. The output unit 31 outputs the received data. An example of the output unit 31 includes a liquid crystal display.

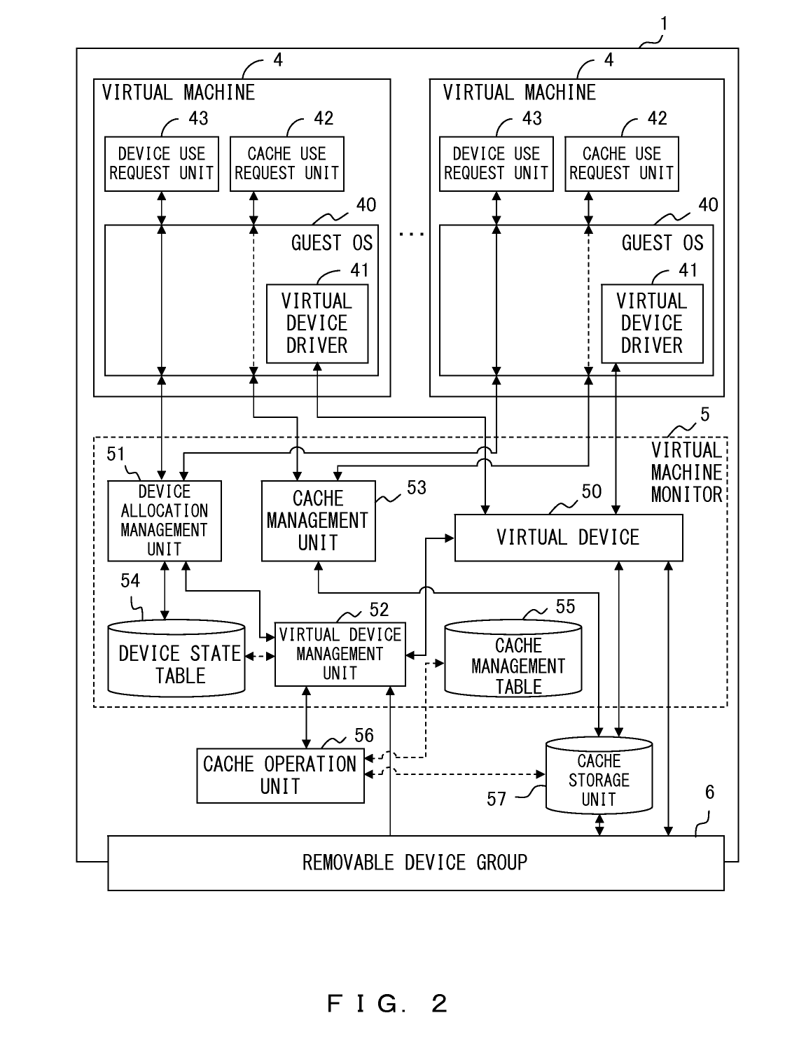

FIG. 2 is a functional block diagram of the information processing device 1 in the first embodiment. The information processing device 1 includes a plurality of virtual machines 4 and a virtual machine monitor 5. The information processing device 1 further includes a cache operation unit 56 and a cache storage unit 57. The information processing device 1 also includes a removable device group 6.

The cache operation unit 56 functions by operation of the CPU 10. The cache storage unit 57 is part of a storage area of the auxiliary storage device 14. The removable device group 6 is an external storage device that reads and writes data to and from the recording medium 2 and is, for example, an interface for attaching and detaching a flexible disk drive, an MO drive, a CD-R drive, a magnetic tape drive, a memory card reader/writer, or a USB memory.

The virtual machines 4 are abstract divisions of the hardware resources of the information processing device 1, and there are a plurality of virtual machines 4. A guest OS 40 controls the virtual machines 4. The virtual machine 4 includes a virtual device driver 41, a cache use request unit 42, and a device use request unit 43. The virtual device driver 41 is stored in the auxiliary storage device 14. The cache use request unit 42 and the device use request unit 43 function by operation of the CPU 10.

The virtual device driver 41 functions as a bridge in order for the guest OS 40 to control a virtual device 50.

The cache use request unit 42 acquires a list related to the cache data stored in the cache storage unit 57 from a cache management unit 53. The cache use request unit 42 causes the output unit 31 of the thin client terminal 3 to output the acquired list as a cache use request screen.

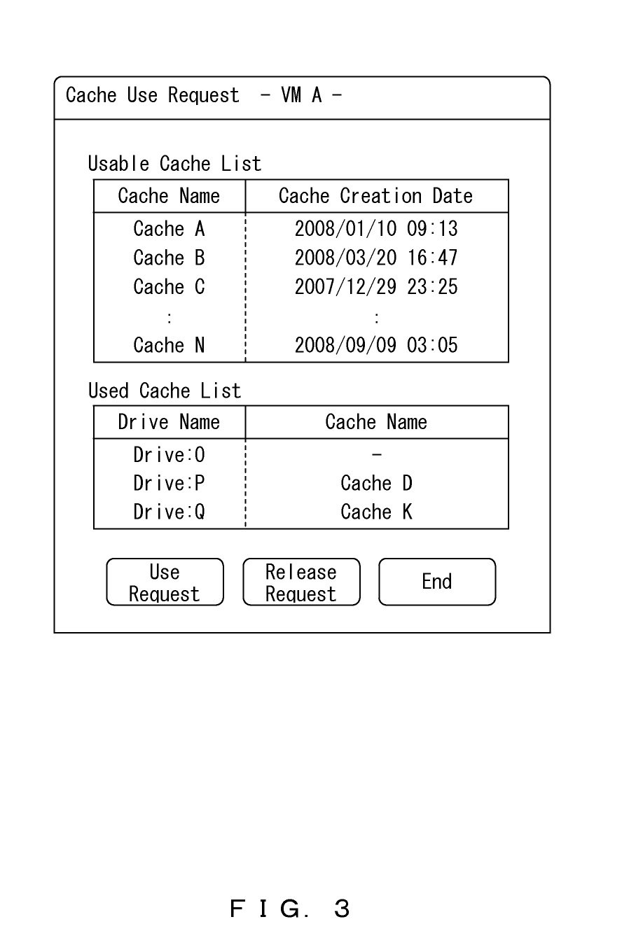

FIG. 3 is a diagram showing an example of display of the cache use request screen. The cache use request screen includes buttons for a use request and a release request of cache. The buttons are pressed through the input unit 30 of the thin client terminal 3. When a button is pressed, the cache use request unit 42 receives input of a use request or a release request of cache data. The cache use request unit 42 outputs the received request to the cache management unit 53.

The device use request unit 43 acquires information related to the virtual device 50 from a device allocation management unit 51 described later. The device use request unit 43 causes the output unit 31 of the thin client terminal 3 to output the acquired information as a device use request screen.

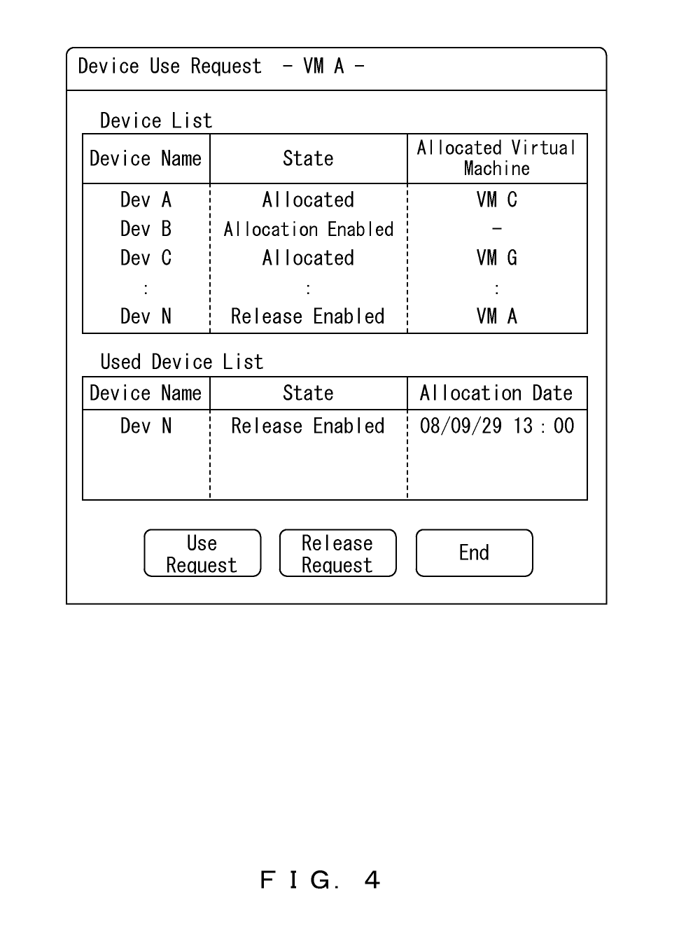

FIG. 4 is a diagram showing an example of display of the device use request screen. The device use request screen includes buttons for a use request and a release request of device. The buttons are pressed through the input unit 30 of the thin client terminal 3. When a button is pressed, the device use request unit 43 receives input of a use request or a release request of the external storage device 11. The device use request unit 43 outputs the received request to the device allocation management unit 51.

The virtual machine monitor 5 detects the use status of the external storage device 11 and allocates the external storage device 11 to the virtual machines 4 based on the detected use status. A host OS and the disclosed computer program control the virtual machine monitor 5.

The virtual machine monitor 5 includes the device allocation management unit 51, a virtual device management unit 52, the cache management unit 53, a device state table 54, and a cache management table 55. The device allocation management unit 51, the virtual device management unit 52, and the cache management unit 53 function by operation of the CPU 10. The device state table 54 and the cache management table 55 are stored in the auxiliary storage device 14.

The device allocation management unit 51 performs control to allocate the external storage device 11 to the virtual machines 4 or to release the external storage device 11 from the virtual machines 4.

### (When Use Request is Received)

When a use request of the external storage device 11 is received, the device allocation management unit 51 accesses the device state table 54. The device allocation management unit 51 extracts the device state of the external storage device 11 from the device state table 54.

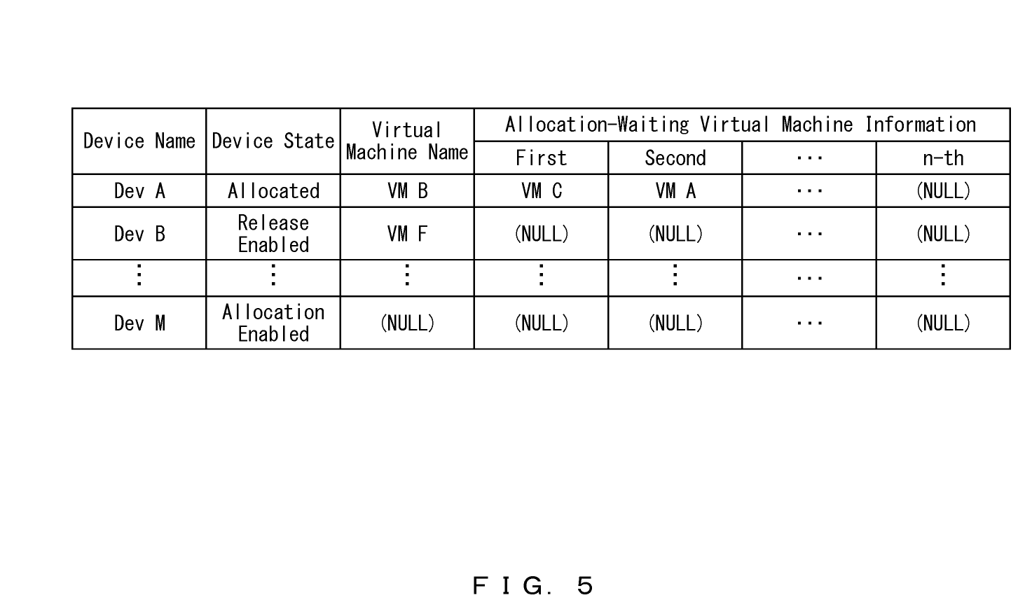

FIG. 5 is a diagram showing an example of format of the device state table 54. The device state table 54 stores device names, device states, virtual machine names, and allocation-waiting virtual machine information.

The device name is information for identifying the virtual device 50. The device state indicates the use status of the external storage device 11. Examples of the device state include an “allocation-enabled state”, an “allocated state”, and a “release-enabled state”.

The allocation-enabled state indicates a state in which the external storage device 11 is not allocated to the virtual machines 4. The allocated state indicates a state in which the external storage device 11 is allocated to the virtual machines 4.

The release-enabled state indicates a state in which the external storage device 11 can be released from the virtual machines 4. The release-enabled state is a state in which the recording medium 2 is attached to the external storage device 11, and the data of the attached recording medium 2 is stored in the cache storage unit 57 as cache data. The release-enabled state continues until a release request is received from the virtual machine 4 allocated to the external storage device 11 or until a use request is received from a virtual machine 4 other than the virtual machine 4 allocated to the external storage device 11.

The virtual machine name is information for identifying the virtual machine 4 allocated to the external storage device 11. The virtual machine name is arbitrarily set by the manager of the system or automatically created by the virtual machine monitor 5 or the CPU 10.

The allocation-waiting virtual machine information is information for identifying allocation-waiting virtual machines 4. The allocation-waiting virtual machine 4 is a virtual machine 4 waiting for the allocation of the external storage device 11 to the virtual machine 4 after the release of the external storage device 11 from the virtual machine 4 allocated to the external storage device 11.

When the device state of the external storage device 11 indicates the allocated state, the device allocation management unit 51 adds, to the allocation-waiting virtual machine information, the virtual machine that has issued a use request. The device allocation management unit 51 outputs a notification indicating that the external storage device 11 is in the allocated state to the device use request unit 43 of the virtual machine 4 that has issued the request.

When the device state of the external storage device 11 indicates the allocation-enabled state, the device allocation management unit 51 allocates the external storage device 11 to the virtual machine 4 that has issued the use request. The device allocation management unit 51 updates the device state of the external storage device 11 from the allocation-enabled state to the allocated state.

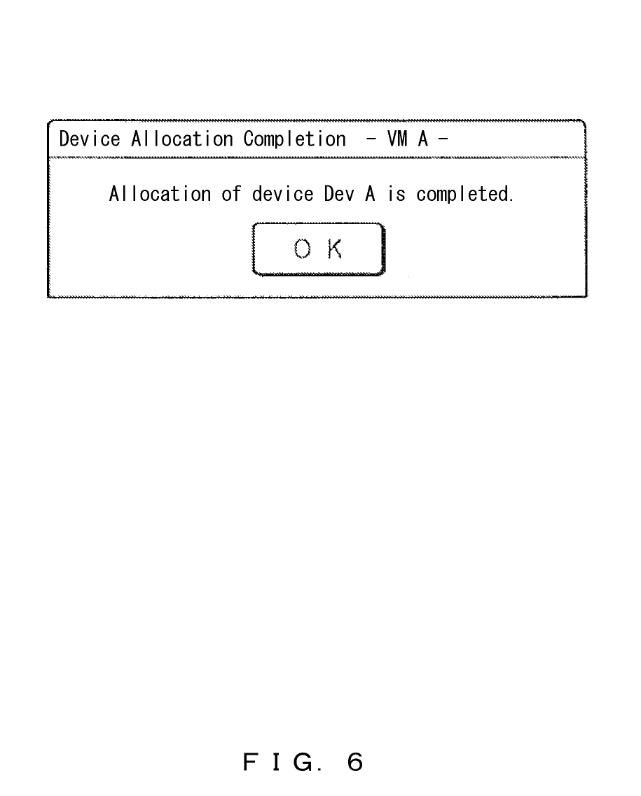

The device allocation management unit 51 outputs a notification of the allocation of the external storage device 11 to the device use request unit 43 of the virtual machine 4 that has issued the request. The device use request unit 43 outputs the received notification to the output unit 31 of the thin client terminal 3. FIG. 6 is a diagram showing an example of display of a message of device allocation completion.

When the device state of the external storage device 11 indicates the release-enabled state, the device allocation management unit 51 requests the virtual device management unit 52 for an unreflected data process. The procedure of the unreflected data process will be described later.

### (When Notification of Unreflected Data Process Completion is Received)

When a notification of the completion of the unreflected data process is received from the virtual device management unit 52, the device allocation management unit 51 updates the device state of the external storage device 11 from the release-enabled state to the allocated state. The device allocation management unit 51 allocates the external storage device 11 to the virtual machine 4 that has issued the use request.

### (When Release Request is Received)

When a release request of the external storage device 11 is received, the device allocation management unit 51 accesses the device state table 54. The device allocation management unit 51 extracts the device state of the external storage device 11 from the device state table 54.

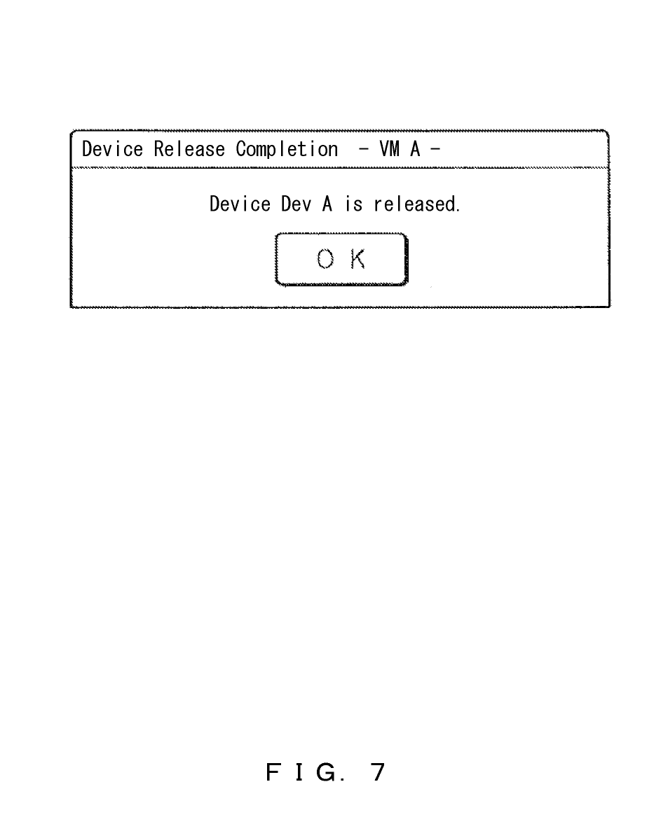

When the device state of the external storage device 11 indicates the allocation-enabled state, the device allocation management unit 51 outputs a notification of the release of the external storage device 11 to the device use request unit 43 of the virtual machine 4 that has issued the release request. The device use request unit 43 outputs the received notification to the output unit 31 of the thin client terminal 3. FIG. 7 is a diagram showing an example of display of a message of device release completion.

When the device state of the external storage device 11 indicates the release-enabled state, the device allocation management unit 51 requests the virtual device management unit 52 for the unreflected data process. The virtual device management unit 52 executes a device releasing process. The procedure of the device releasing process will be described later.

When a notification of the completion of the unreflected data process is received from the virtual device management unit 52, the device allocation management unit 51 determines whether the recording medium 2 is attached to the external storage device 11.

When the device allocation management unit 51 determines that the recording medium 2 is detached, the device allocation management unit 51 updates the device state of the external storage device 11 from the release-enabled state to the allocation-enabled state. The device allocation management unit 51 outputs a notification of the release of the external storage device 11 to the device use request unit 43 of the virtual machine 4 that has issued the release request. The device use request unit 43 outputs the received notification to the output unit 31 of the thin client terminal 3.

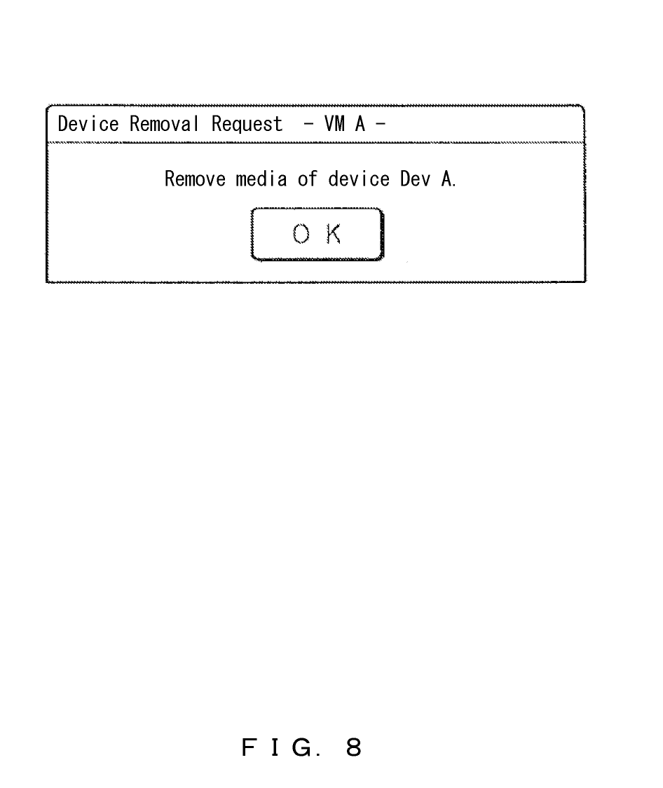

Meanwhile, when the device allocation management unit 51 determines that the recording medium 2 is attached, the device allocation management unit 51 outputs a notification for prompting the removal of the recording medium 2 to the device use request unit 43 of the virtual machine 4 that has issued the release request. The device use request unit 43 outputs the received notification to the output unit 31 of the thin client terminal 3. FIG. 8 is a diagram showing an example of display of a message of a media removal request.

The device allocation management unit 51 maintains the device state of the external storage device 11 to the release-enabled state during the execution of the device releasing process. When the device releasing process is completed, the device allocation management unit 51 updates the device state of the external storage device 11 from the release-enabled state to the allocation-enabled state.

The device allocation management unit 51 outputs a notification of the release of the external storage device 11 to the device use request unit 43 of the virtual machine that has issued the release request. The device use request unit 43 outputs the received notification to the output unit 31 of the thin client terminal 3.

When the device state of the external storage device 11 indicates the allocated state, the device allocation management unit 51 requests the virtual device management unit 52 for the device releasing process.

### (When Notification of Release of External Storage Device 11 is Received)

When a notification of the release of the external storage device 11 is received from the virtual device management unit 52, the device allocation management unit 51 outputs a notification for prompting the removal of the recording medium 2 to the device use request unit 43 of the virtual machine 4 allocated to the external storage device 11. The device use request unit 43 outputs the received notification to the output unit 31 of the thin client terminal 3.

### (When Request for Changing Device State is Received)

When a request for changing the device state of the external storage device 11 is received from the virtual device management unit 52, the device allocation management unit 51 updates the device state to the requested state. The device allocation management unit 51 outputs a notification of the change in the device state to the virtual device management unit 52.

### (When Request for Attaching Recording Medium 2 is Received)

When a request for attaching the recording medium 2 is received from the virtual device management unit 52, the device allocation management unit 51 outputs, to the device use request unit 43 of the virtual machine 4 allocated to the external storage device 11, information related to the recording medium 2 that should be attached and a notification for prompting the attachment of the recording medium 2. The device use request unit 43 outputs the received notification to the output unit 31 of the thin client terminal 3.

### (When Notification of Storage of Cache Data is Received)

When a notification of the storage of the data of the recording medium 2 as cache data is received from the virtual device management unit 52, the device allocation management unit 51 updates the device state of the external storage device 11 from the allocated state to the release-enabled state.

The device allocation management unit 51 further checks whether there is an allocation-waiting virtual machine 4. When the device allocation management unit 51 checks that there is an allocation-waiting virtual machine 4, the device allocation management unit 51 allocates the external storage device 11 in the release-enabled state to the allocation-waiting virtual machine 4.

### (When Notification of Occurrence of Access Error is Received)

When a notification of occurrence of an access error to the recording medium 2 is received from the virtual device management unit 52, the device allocation management unit 51 outputs the notification of occurrence of the access error to the device use request unit 43 of the virtual machine 4 allocated to the external storage device 11. The device use request unit 43 outputs the received notification to the output unit 31 of the thin client terminal 3.

### (When Request for Accessing Cache Data is Received)

When a request for accessing the cache data stored in the cache storage unit 57 is received from the cache management unit 53, the device allocation management unit 51 outputs information related to the cache data to be accessed and the request for accessing the cache data to the virtual device management unit 52.

When the notification for accessing the cache data is received from the virtual device management unit 52, the device allocation management unit 51 accesses the device state table 54. When the device state of the external storage device 11 indicates one of the allocated state and the release-enabled state and the device allocation management unit 51 determines that the recording medium 2 is attached to the external storage device 11, the device allocation management unit 51 outputs a notification for prompting the removal of the recording medium 2 to the device use request unit 43 of the virtual machine 4 allocated to the external storage device 11. The device use request unit 43 outputs the received notification to the output unit 31 of the thin client terminal 3.

The device allocation management unit 51 updates the device state of the external storage device 11 to the allocation-enabled state. The device allocation management unit 51 outputs the notification for accessing the cache data to the cache management unit 53.

The virtual device management unit 52 controls the virtual device 50. The virtual device management unit 52 receives, from the removable device group 6, attachment information indicating whether the recording medium 2 is attached to the external storage device 11.

### (When Notification of Attachment of Recording Medium 2 is Received)

When a notification of the attachment of the recording medium 2 is received from the removable device group 6, the virtual device management unit 52 changes the access location of the virtual device 50 from the cache storage unit 57 to the recording medium 2. The virtual device management unit 52 outputs, to the device allocation management unit 51, a request for changing the device state of the external storage device 11 to the allocated state.

### (When Notification of Change in Device State is Received)

When a notification of the change in the device state of the external storage device 11 is received from the device allocation management unit 51, the virtual device management unit 52 checks whether the unreflected data process is requested to the cache operation unit 56. When the virtual device management unit 52 determines that the unreflected data process is requested to the cache operation unit 56, the virtual device management unit 52 again requests the cache operation unit 56 for the unreflected data process.

Meanwhile, when the virtual device management unit 52 determines that the unreflected data process is not requested to the cache operation unit 56, the virtual device management unit 52 outputs a request for storing the data of the recording medium 2 as cache data to the cache operation unit 56.

When a notification of the storage of the cache data is received from the cache operation unit 56, the virtual device management unit 52 changes the access location of the virtual device 50 from the recording medium 2 to the cache storage unit 57. The virtual device management unit 52 outputs the notification of the storage of the cache data to the device allocation management unit 51.

### (When Notification of Detachment of Recording Medium 2 is Received)

When a notification of the detachment of the recording medium 2 is received from the removable device group 6, the virtual device management unit 52 outputs the received notification to the device allocation management unit 51.

### (When Device Releasing Process is Requested)

When the device releasing process is requested from the device allocation management unit 51, the virtual device management unit 52 outputs a request to stop storing the data of the recording medium 2 as cache data to the cache operation unit 56.

### (When Notification of Stop of Storage of Cache Data is Received)

When a notification of the stop of the storage of the data of the recording medium 2 as cache data is received from the cache operation unit 56, the virtual device management unit 52 changes the access location of the virtual device 50 to “NULL”. The virtual device management unit 52 outputs a notification of the release of the external storage device 11 to the device allocation management unit 51.

### (When Notification of Completion of Unreflected Data Process is Received)

When a notification of the completion of the unreflected data process is received from the cache operation unit 56, the virtual device management unit 52 changes the access location of the virtual device 50 to “NULL”. The virtual device management unit 52 outputs a notification of the change in the access location of the virtual device 50 to the device allocation management unit 51.

### (When Request for Replacing Recording Medium 2 is Received)

When information related to the recording medium 2 that should be attached and a request for replacing the recording medium 2 are received from the removable device group 6, the virtual device management unit 52 outputs, to the device allocation management unit 51, the information related to the recording medium 2 that should be attached and a request for attaching the recording medium 2. The information related to the recording medium 2 that should be attached includes a type of media, a media identifier, a data start position, a data end position, a cache storage location, and a cache file name.

When the information related to the recording medium 2 that should be attached and the request for replacing the recording medium 2 are received from the cache operation unit 56, the virtual device management unit 52 outputs, to the device allocation management unit 51, the information related to the recording medium 2 that should be attached and the request for attaching the recording medium 2.

### (When Notification of Completion of Replacement of Recording Medium 2 is Received)

When a notification of the completion of the replacement of the recording medium 2 of the external storage device 11 is received from the device allocation management unit 51, the virtual device management unit 52 requests the cache operation unit 56 for the unreflected data process.

When a notification of the completion of the unreflected data process is received from the cache operation unit 56, the virtual device management unit 52 changes the access location of the virtual device 50 from the recording medium 2 to the cache storage unit 57. The virtual device management unit 52 outputs a notification of the change in the access location of the virtual device 50 to the device allocation management unit 51.

### (When Notification of Occurrence of Access Error is Received)

When a notification of occurrence of an access error is received through the virtual device 50, the virtual device management unit 52 outputs the received notification to the device allocation management unit 51.

The cache management unit 53 outputs the information related to the cache data stored in the cache storage unit 57 to the cache use request unit 42 of the virtual machine 4. The cache management unit 53 checks the status of the cache storage unit 57 every time a predetermined time has passed. The cache management unit 53 deletes the cache data stored for a predetermined period or cache data with low use frequency from the cache storage unit 57.

### (When Cache Use Request is Received)

When a use request of the cache data stored in the cache storage unit 57 is received from the cache use request unit 42 of the virtual machine 4, the cache management unit 53 outputs, to the device allocation management unit 51, information related to the cache data and a request for changing the access location of the virtual device 50 to the cache data. When a notification of the change of the access location of the virtual device 50 to the cache data is received from the device allocation management unit 51, the cache management unit 53 outputs the received notification to the cache use request unit 42 of the virtual machine 4.

### (When Cache Release Request is Received)

When a release request of the cache data stored in the cache storage unit 57 is received from the cache use request unit 42 of the virtual machine 4, the cache management unit 53 outputs, to the device allocation management unit 51, a request for changing the access location of the virtual device 50. The device allocation management unit 51 changes the access location of the virtual device 50 to “NULL”. As a result, the cache data is released from the virtual machine 4.

When a notification of the change in the access location of the virtual device 50 is received from the device allocation management unit 51, the cache management unit 53 outputs a notification of the release of the cache data to the cache use request unit 42 of the virtual machine 4.

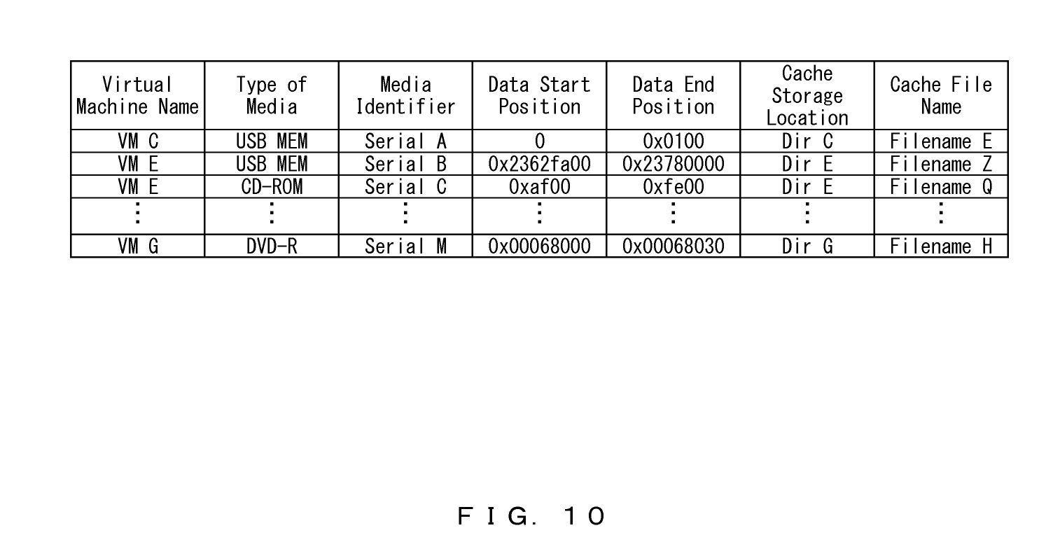

FIG. 10 is a diagram showing an example of format of the cache management table 55. The cache management table 55 is a table for storing information related to unreflected data. The unreflected data is data that should be written to the recording medium 2 and that is not reflected on the recording medium 2 yet.

The information related to the unreflected data includes a virtual machine name, a type of media, a media identifier, a start position of data, an end position of data, a cache storage location, and a cache file name. The data is deleted from the cache management table 55 when the unreflected data is written to the recording medium 2.

The virtual machine name is information for identifying the virtual machine 4 including unreflected data. Examples of the type of media include a CD-R, a DVD-RAM, and a USB memory. The media identifier is information for identifying the recording medium 2, such as a volume name of the recording medium 2.

The data start position is a writing start position of the unreflected data in the recording medium 2. The data end position is a writing end position of the unreflected data in the recording medium 2. The cache storage location is information for identifying stored directories in the cache storage unit 57. The cache file name is a file name of the cache data in the cache storage unit 57.

The cache operation unit 56 executes a storage process and an unreflected data process of the data of the recording medium 2.

### (When Request for Storing Cache Data is Received)

When a request for storing the data of the recording medium 2 as cache data is received from the virtual device management unit 52, the cache operation unit 56 checks whether the cache data is stored in the cache storage unit 57.

When the cache operation unit 56 determines that the data of the recording medium 2 is not stored in the cache storage unit 57, the cache operation unit 56 stores, in the cache storage unit 57, the data of the recording medium 2 attached to the external storage device 11 as cache data. The cache storage unit 57 outputs a notification of the storage of the cache data to the virtual device management unit 52.

Meanwhile, if the cache operation unit 56 determines that the cache data is stored in the cache storage unit 57, the cache operation unit 56 further checks whether there is a difference between the data of the recording medium 2 and the cache data stored in the cache storage unit 57. When the cache operation unit 56 determines that there is no difference, the cache operation unit 56 outputs a notification of the storage of the cache data to the virtual device management unit 52.

Meanwhile, when the cache operation unit 56 determines that there is a difference, the cache operation unit 56 updates the cache data by difference data.

The cache operation unit 56 checks whether information related to the unreflected data is stored in the cache management table 55. When the cache operation unit 56 determines that the information related to the unreflected data is not stored in the cache management table 55, the cache operation unit 56 writes the information related to the unreflected data to the cache management table 55. The cache operation unit 56 outputs, to the virtual device management unit 52, a notification of the writing of the information related to the unreflected data in the cache management table 55.

Meanwhile, when the cache operation unit 56 determines that the information related to the unreflected data is stored in the cache management table 55, the cache operation unit 56 writes the unreflected data to the recording medium 2. The cache operation unit 56 outputs a notification of the completion of the unreflected data process to the virtual device management unit 52.

### (When Unreflected Data Process is Requested)

When the unreflected data process is requested from the virtual device management unit 52, the cache operation unit 56 checks whether information related to unreflected data is stored in the cache management table 55. The request herein denotes a request for writing the unreflected data to the recording medium 2 attached to the external storage device 11.

When the cache operation unit 56 determines that the information related to the unreflected data is not stored in the cache management table 55, the cache operation unit 56 outputs a notification of the completion of the unreflected data process to the virtual device management unit 52.

Meanwhile, when the cache operation unit 56 determines that the information related to the unreflected data is stored in the cache management table 55, the cache operation unit 56 writes the unreflected data to the recording medium 2. The cache operation unit 56 deletes the information related to the unreflected data finished with writing from the cache management table 55. The cache operation unit 56 outputs a notification of the completion of the unreflected data process to the virtual device management unit 52.

When the unreflected data process is requested from the virtual device management unit 52, the cache operation unit 56 checks whether information related to the unreflected data is stored in the cache management table 55. The request herein denotes a request for writing the unreflected data to the recording medium 2 having a writing location of the unreflected data.

The writing location of the unreflected data is a storage area instructed by the virtual machine 4. When the cache operation unit 56 determines that the information related to the unreflected data is not stored in the cache management table 55, the cache operation unit 56 outputs a notification of the completion of the unreflected data process to the virtual device management unit 52.

Meanwhile, when the cache operation unit 56 determines that the information related to the unreflected data is stored in the cache management table 55, the cache operation unit 56 checks whether the recording medium 2 is attached to the external storage device 11.

When the cache operation unit 56 determines that the recording medium 2 is not attached to the external storage device 11, the cache operation unit 56 outputs, to the virtual device management unit 52, information related to the recording medium 2 to which the unreflected data should be written and a request for replacing the recording medium 2. The recording medium 2 to which the unreflected data should be written is a recording medium 2 accessible by the virtual machine 4. When the virtual device management unit 52 determines that the recording medium 2 is attached to the external storage device 11, the virtual device management unit 52 again requests the cache operation unit 56 for the unreflected data process.

When the unreflected data process is requested again from the virtual device management unit 52, or when the cache operation unit 56 determines that the recording medium 2 is attached to the external storage device 11, the cache operation unit 56 writes the unreflected data to the attached recording medium 2. The cache operation unit 56 deletes the information related to the unreflected data finished with writing from the cache management table 55. The cache operation unit 56 outputs a notification of the completion of the unreflected data process to the virtual device management unit 52.

### (When Request to Stop Storing Cache Data is Received)

When a request to stop storing the data of the recording medium 2 as cache data is received from the virtual device management unit 52, the cache operation unit 56 stops storing the cache data and deletes the cache data being stored. The cache operation unit 56 outputs a notification of the stop of the storage of the cache data to the virtual device management unit 52.

The cache storage unit 57 stores the data of the recording medium 2 attached to the external storage device 11 as cache data according to an instruction of the CPU 10.

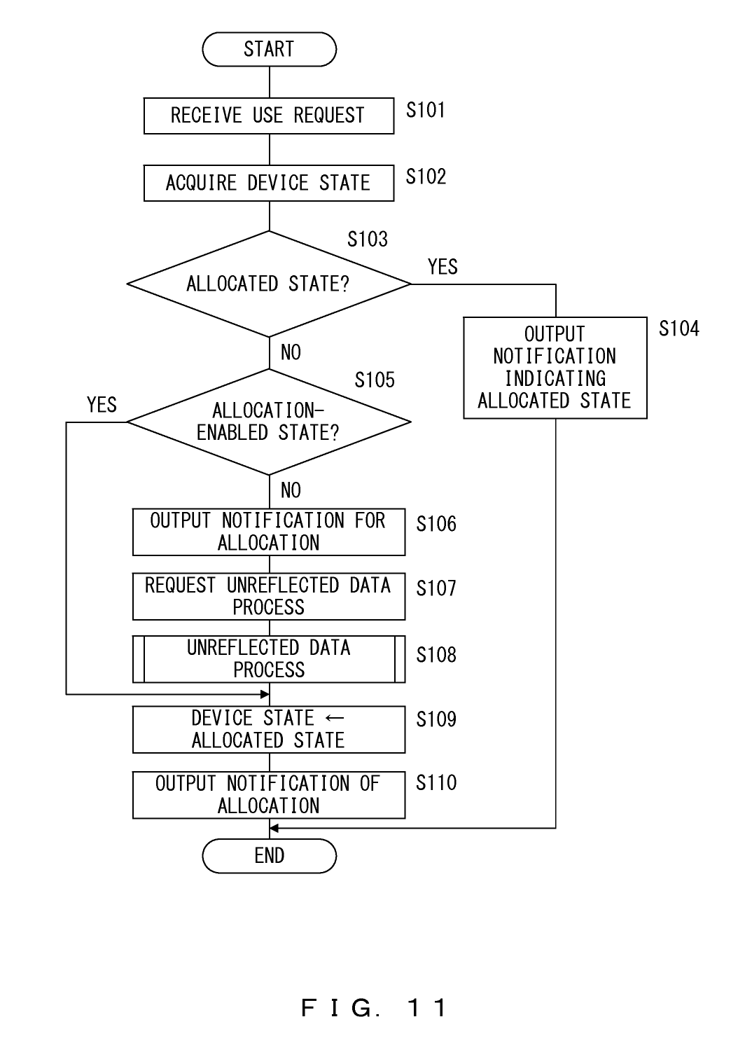

The information processing device 1 uses the resources above to execute the following process. FIG. 11 is a flow chart showing a procedure of a basic device allocation process. The virtual machine 4 receives a use request of the external storage device 11. The virtual machine 4 outputs the use request to the virtual machine monitor 5.

The virtual machine monitor 5 receives a use request from the virtual machine 4 (S101). The virtual machine monitor 5 acquires the device state of the external storage device 11 from the device state table 54 (S102). The virtual machine monitor 5 checks whether the acquired device state indicates the allocated state (S103).

When the virtual machine monitor 5 determines that the device state indicates the allocated state (YES in S103), the virtual machine monitor 5 adds the name of the virtual machine that has issued the use request to allocation-waiting virtual machine information. The virtual machine monitor 5 outputs a notification indicating that the external storage device 11 is in the allocated state to the virtual machine 4 that has issued the use request (S104). The information processing device 1 ends the process.

Meanwhile, when the virtual machine monitor 5 determines that the device state does not indicate the allocated state (NO in S103), the virtual machine monitor 5 further checks whether the device state indicates the allocation-enabled state (S105). When the virtual machine monitor 5 determines that the device state indicates the allocation-enabled state (YES in S105), the virtual machine monitor 5 allocates the external storage device 11 to the virtual machine 4 that has issued the use request and proceeds to step S109.

Meanwhile, when the virtual machine monitor 5 determines that the device state does not indicate the allocation-enabled state (NO in S105), the virtual machine monitor 5 outputs, to the virtual machine 4 allocated to the external storage device 11, a notification of new allocation of the external storage device 11 to a virtual machine 4 other than the virtual machine 4 allocated to the external storage device 11 that has issued the use request (S106). The virtual machine 4 outputs the received notification to the output unit 31 of the thin client terminal 3.

The virtual machine monitor 5 requests the unreflected data process to the cache operation unit 56 (S107). The virtual machine monitor 5 enters a standby state, and the cache operation unit 56 executes the unreflected data process (S108). The procedure of the unreflected data process will be described later. The virtual machine monitor 5 proceeds to step S109 after the completion of the unreflected data process.

When the virtual machine monitor 5 determines that the device state indicates the allocation-enabled state (YES in S105), or when the unreflected data process is completed (S108), the virtual machine monitor 5 changes the device state of the external storage device 11 to the allocated state (S109). The virtual machine monitor 5 outputs a notification of the allocation of the external storage device 11 to the virtual machine 4 that has issued the use request (S110). The virtual machine monitor 5 ends the process.

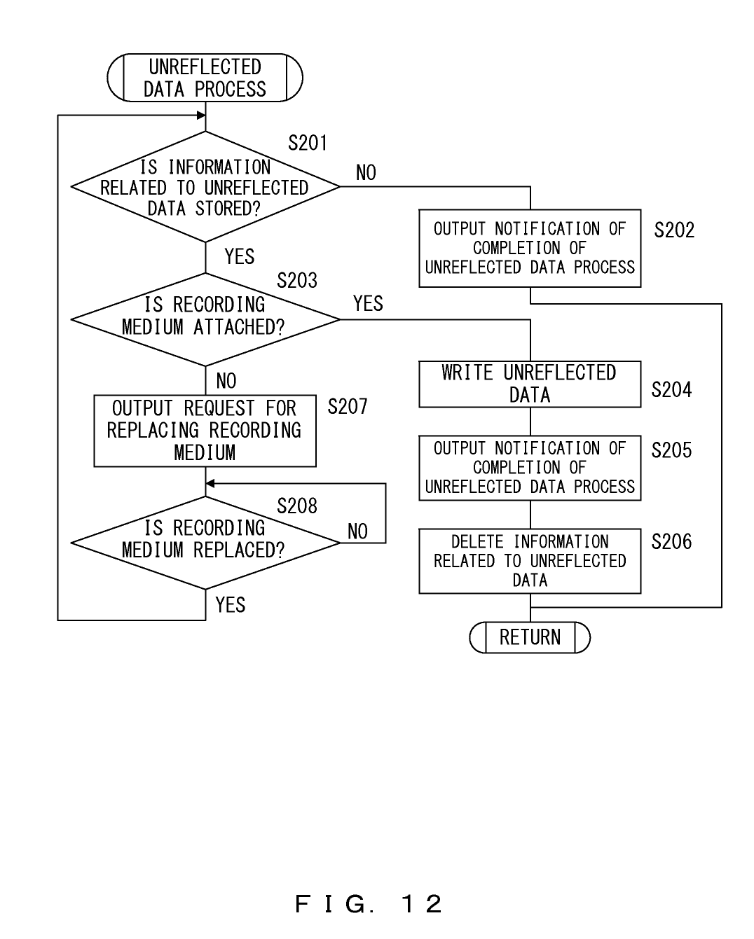

A procedure of the unreflected data process as a sub-routine will be described. FIG. 12 is a flow chart showing the procedure of the unreflected data process. The virtual machine monitor 5 requests the unreflected data process the cache operation unit 56.

The cache operation unit 56 checks whether information related to the unreflected data is stored in the cache management table 55 (S201). When the cache operation unit 56 determines that the information related to the unreflected data is not stored in the cache management table 55 (NO in S201), the cache operation unit 56 outputs a notification of the completion of the unreflected data process to the virtual machine monitor 5 (S202). The virtual machine monitor 5 returns to the main routine.

Meanwhile, when the cache operation unit 56 determines that the information related to the unreflected data is stored in the cache management table 55 (YES in S201), the cache operation unit 56 checks whether the recording medium 2 is attached to the external storage device 11 (S203). When the cache operation unit 56 determines that the recording medium 2 is attached to the external storage device 11 (YES in S203), the cache operation unit 56 writes the unreflected data to the attached recording medium 2 (S204).

The recording medium 2 to which the unreflected data should be written is a recording medium 2 having a writing location of the unreflected data. The writing location of the unreflected data is a storage area instructed by the virtual machine 4. The cache operation unit 56 queries whether there is the instructed storage area to the virtual device 50. When a notification of the existence of the instructed storage area is received from the virtual device 50, the cache operation unit 56 determines that the attached recording medium 2 is the recording medium 2 to which the unreflected data should be written.

The cache operation unit 56 outputs a notification of the completion of the unreflected data process to the virtual machine monitor 5 (S205). The virtual machine monitor 5 changes the device state of the external storage device 11 to the allocated state. The virtual machine monitor 5 outputs, to the cache operation unit 56, a request for deleting the information related to the unreflected data finished with writing from the cache management table 55.

The cache operation unit 56 deletes the information related to the unreflected data finished with writing from the cache management table 55 (S206). The virtual machine monitor 5 returns to the main routine.

Meanwhile, when the cache operation unit 56 determines that the recording medium 2 is not attached to the external storage device 11 (NO in S203), the cache operation unit 56 outputs, to the virtual machine monitor 5, information related to the recording medium 2 that should be attached and a request for replacing the recording medium 2 (S207).

When a notification indicating that the instructed storage area does not exist is received from the virtual device 50, the cache operation unit 56 determines that the recording medium 2 is not attached to the external storage device 11. Cases in which the recording medium 2 is not attached include a case in which the recording medium 2 is not physically attached and a case in which the recording medium 2 to which the unreflected data should be written is not attached.

The virtual machine monitor 5 outputs, to the virtual machine 4, information related to the recording medium 2 that should be attached and a notification for prompting the attachment of the recording medium 2. The virtual machine 4 outputs the received notification to the output unit 31 of the thin client terminal 3.

The cache operation unit 56 checks whether the recording medium 2 is replaced (S208). When the cache operation unit 56 determines that the recording medium 2 is not replaced (NO in S208), the cache operation unit 56 repeats the determination of step S208.

Meanwhile, when the cache operation unit 56 determines that the recording medium 2 is replaced (YES in S208), the cache operation unit 56 returns to step S201 and repeats the unreflected data process. When the unreflected data process is requested again from the virtual machine monitor 5, the cache operation unit 56 determines that the recording medium 2 is replaced.

In this way, the information processing device 1 can write the unreflected data handled by the virtual device 50 to the recording medium 2 that is a physical resource.

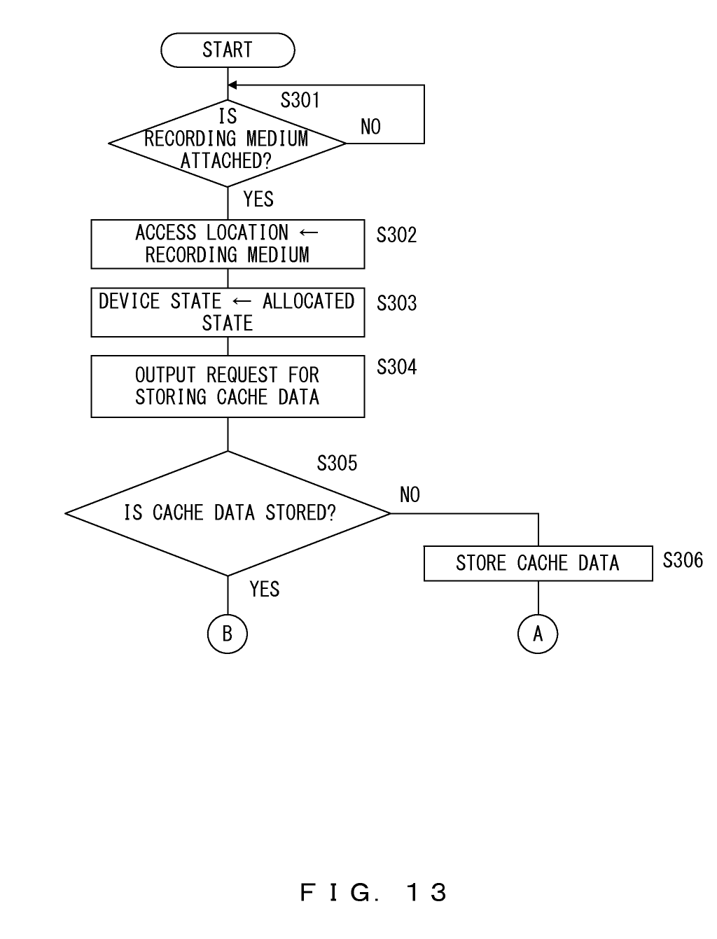

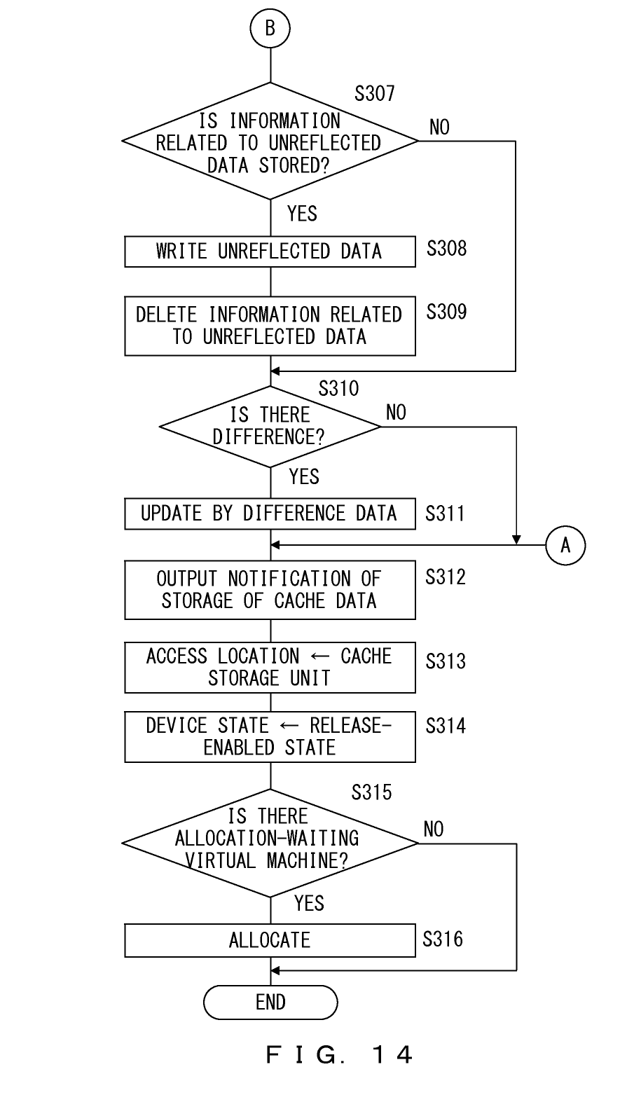

FIGS. 13 and 14 are flow charts showing a procedure of a basic control process when the recording medium 2 is attached. The external storage device 11 outputs, to the virtual machine monitor 5, information indicating whether the recording medium 2 is attached. The virtual machine monitor 5 checks whether the recording medium 2 is attached to the external storage device 11 (S301). When the virtual machine monitor 5 determines that the recording medium 2 is not attached to the external storage device 11 (NO in S301), the virtual machine monitor 5 repeats the determination of step S301.

Meanwhile, when the virtual machine monitor 5 determines that the recording medium 2 is attached to the external storage device 11 (YES in S301), the virtual machine monitor 5 changes the access location of the virtual device 50 to the recording medium 2 (S302). The virtual machine monitor 5 changes the device state of the external storage device 11 to the allocated state (S303). The virtual machine monitor 5 outputs a request for storing the data of the recording medium 2 as cache data to the cache operation unit 56 (S304).

The cache operation unit 56 checks whether the cache data is stored in the cache storage unit 57 (S305). When the cache operation unit 56 determines that the cache data is not stored in the cache storage unit 57 (NO in S305), the cache operation unit 56 stores the data of the recording medium 2 attached to the external storage device 11 in the cache storage unit 57 as cache data (S306). The cache operation unit 56 proceeds to step S312.

Meanwhile, when the cache operation unit 56 determines that the cache data is stored in the cache storage unit 57 (YES in S305), the cache operation unit 56 checks whether information related to the unreflected data is stored in the cache management table 55 (S307). When the cache operation unit 56 determines that the information related to the unreflected data is not stored in the cache management table 55 (NO in S307), the cache operation unit 56 proceeds to step S310.

Meanwhile, when the cache operation unit 56 determines that the information related to the unreflected data is stored in the cache management table 55 (YES in S307), the cache operation unit 56 writes the unreflected data to the attached recording medium 2 (S308). The cache operation unit 56 deletes the information related to the unreflected data finished with writing from the cache management table 55 (S309).

When the cache operation unit 56 determines that the information related to the unreflected data is not stored (NO in S307), or when the information related to the unreflected data finished with writing is deleted from the cache management table 55 (S309), the cache operation unit 56 checks whether there is a difference between the data of the recording medium 2 and the cache data stored in the cache storage unit 57 (S310). When the cache operation unit 56 determines that there is no difference between the data of the recording medium 2 and the cache data stored in the cache storage unit 57 (NO in S310), the cache operation unit 56 proceeds to step S312.

Meanwhile, when the cache operation unit 56 determines that there is a difference between the data of the recording mediums 2 and the cache data stored in the cache storage unit 57 (YES in S310), the cache operation unit 56 updates the cache data by difference data (S311). The cache operation unit 56 proceeds to step S312.

When the data is stored in the cache storage unit 57 as cache data (S306), when the cache operation unit 56 determines that there is no difference between the data of the recording medium 2 and the cache data (NO in S310), or when the cache data is updated by the difference data (S311), the cache operation unit 56 outputs a notification of the storage of the cache data to the virtual machine monitor 5 (S312).

The virtual machine monitor 5 changes the access location of the virtual device 50 to the cache storage unit 57 (S313). The virtual machine monitor 5 changes the device state of the external storage device 11 to the release-enabled state (S314). The virtual machine monitor checks whether there is an allocation-waiting virtual machine 4 (S315). When the virtual machine monitor 5 determines that there is no allocation-waiting virtual machine 4 (NO in S315), the virtual machine monitor 5 ends the process.

Meanwhile, when the virtual machine monitor 5 determines that there is an allocation-waiting virtual machine 4 (YES in S315), the virtual machine monitor 5 allocates the external storage device 11 to the allocation-waiting virtual machine 4 (S316). The basic device allocation process is followed to allocate the external storage device 11. The virtual machine monitor 5 ends the process.

In this way, the information processing device 1 can release early the external storage device 11 attached the recording medium 2 from the virtual machine 4 allocated to the external storage device 11. The information processing device 1 can quickly allocate the released external storage device 11 to the allocation-waiting virtual machine.

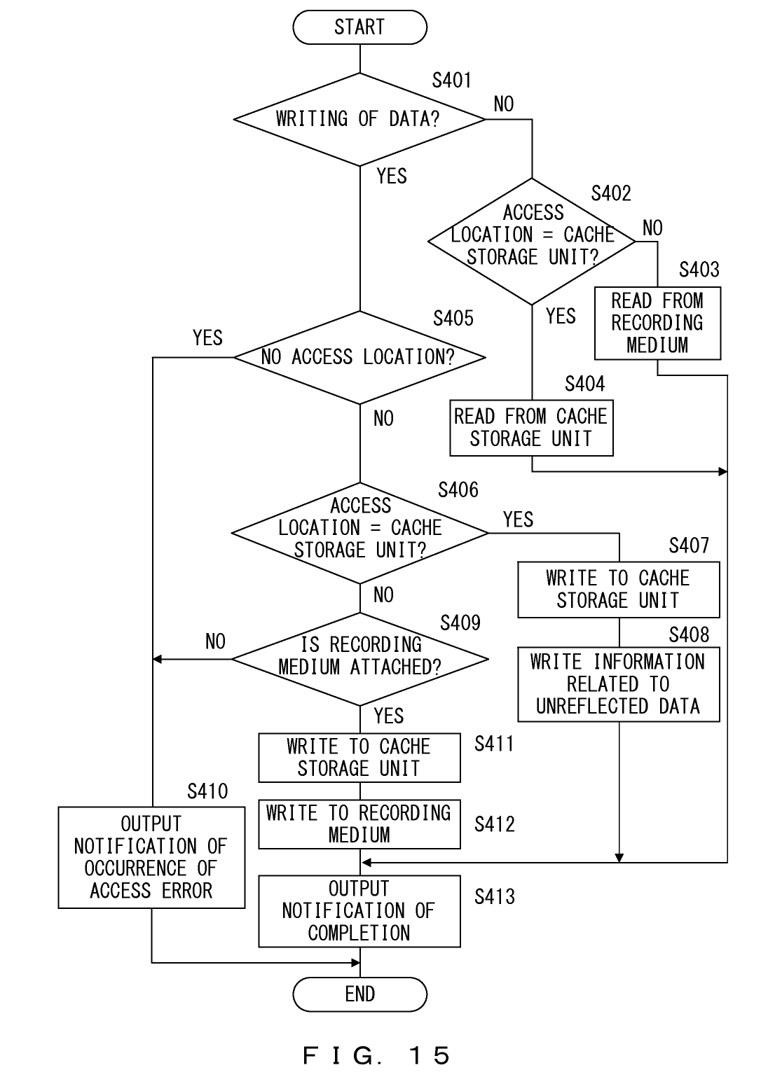

FIG. 15 is a flow chart showing a procedure of a basic reading/writing process for the recording medium 2. The virtual machine 4 accesses the virtual device 50 through the virtual device driver 41 in accordance with application software.

The virtual device 50 checks whether a request of the application software indicates writing of data (S401). When the virtual device 50 determines that the request does not indicate writing of data (NO in S401), the virtual device 50 checks whether the access location of the virtual device 50 is the cache storage unit 57 (S402).

The virtual device 50 queries the access location of the virtual device 50 to the virtual machine monitor 5. When the virtual device 50 determines that the access location is not the cache storage unit 57 (NO in S402), the virtual device 50 reads data from the recording medium 2 (S403). The virtual device 50 outputs a notification of the completion of reading of the data to the virtual machine 4 (S413). The virtual device 50 ends the process.

Meanwhile, when the virtual device 50 determines that the access location of the virtual device 50 is the cache storage unit 57 (YES in S402), the virtual device 50 reads data from the cache storage unit 57 (S404). The virtual device 50 outputs a notification of the completion of reading of the data to the virtual machine 4 (S413). The virtual device 50 ends the process.

Meanwhile, when the virtual device 50 determines that the request indicates writing of data (YES in S401), the virtual device 50 checks whether there is an access location of the virtual device 50 (S405). When the virtual device 50 determines that there is no access location of the virtual device 50 (YES in S405), the virtual device 50 outputs a notification of occurrence of an access error to the virtual machine monitor 5 (S410). The virtual machine monitor 5 outputs the received notification to the virtual machine 4. The virtual machine 4 outputs the received notification to the output unit 31 of the thin client terminal 3. The virtual device 50 ends the process.

When the virtual device 50 determines that there is an access location of the virtual device 50 (NO in S405), the virtual device 50 checks whether the access location of the virtual device 50 is the cache storage unit 57 (S406). When the virtual device 50 determines that the access location of the virtual device 50 is the cache storage unit 57 (YES in S406), the virtual device 50 writes data to the cache storage unit 57 (S407). The data written to the cache storage unit 57 is unreflected data until the data is written to the recording medium 2.

The virtual machine monitor 5 writes information related to the unreflected data to the cache management table 55 (S408). The virtual device 50 outputs a notification of the completion of writing of the data to the virtual machine 4 (S413). The virtual device 50 ends the process.

Meanwhile, when the virtual device 50 determines that the access location of the virtual device 50 is not the cache storage unit 57 (NO in S406), the virtual device 50 checks whether the recording medium 2 is attached to the external storage device 11 (S409).

When the virtual device 50 determines that the recording medium 2 is not attached to the external storage device 11 (NO in S409), the virtual device 50 outputs a notification of occurrence of an access error to the virtual machine monitor 5 (S410). The virtual machine monitor 5 outputs the received notification to the virtual machine 4. The virtual machine 4 outputs the received notification to the output unit 31 of the thin client terminal 3. The virtual machine monitor 5 ends the process.

Meanwhile, when the virtual device 50 determines that the recording medium 2 is attached to the external storage device 11 (YES in S409), the virtual device 50 writes the data to the cache storage unit 57 (S411). The virtual device 50 writes the data to the recording medium 2 (S412). The virtual device 50 outputs a notification of the completion of writing of the data to the virtual machine 4 (S413). The virtual device 50 ends the process.

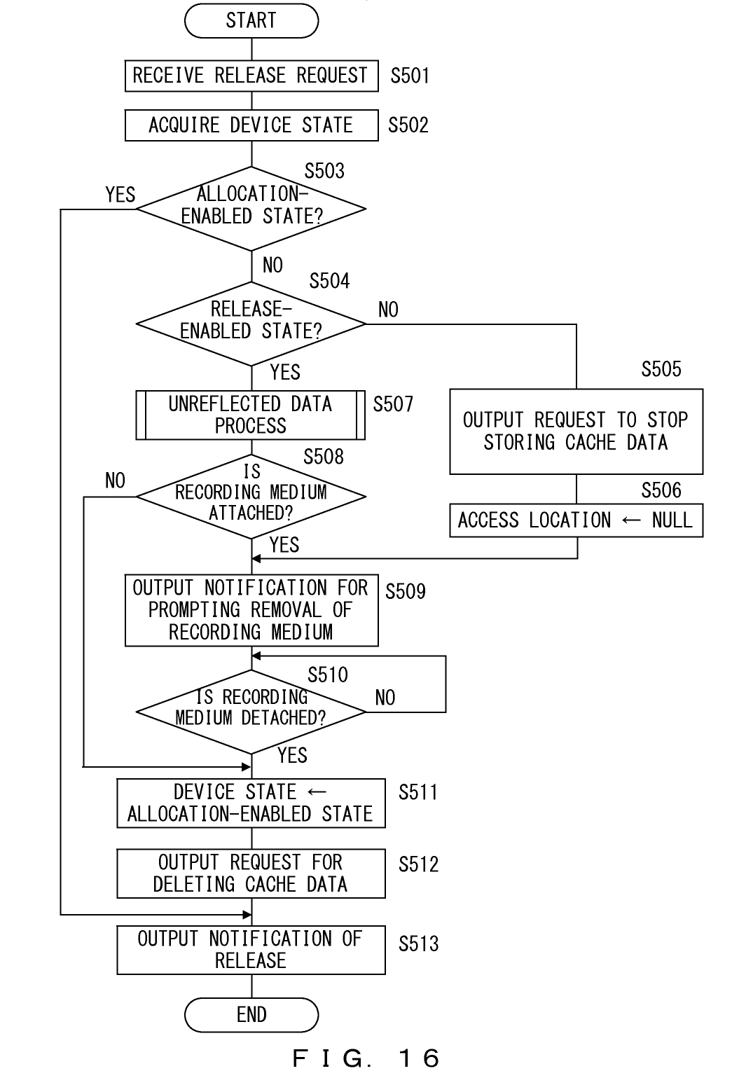

FIG. 16 is a flow chart showing a procedure of a basic device releasing process. The virtual machine 4 receives a release request of the external storage device 11. The virtual machine 4 outputs the release request to the virtual machine monitor 5. The virtual machine monitor 5 receives the release request outputted from the virtual machine 4 (S501).

The virtual machine monitor 5 acquires the device state of the external storage device 11 from the device state table 54 (S502). The virtual machine monitor 5 checks whether the acquired device state indicates the allocation-enabled state (S503).

When the virtual machine monitor 5 determines that the device state indicates the allocation-enabled state (YES in S503), the virtual machine monitor 5 outputs a notification of the release of the external storage device 11 to the virtual machine 4 (S513). The virtual machine 4 outputs the received notification to the output unit 31 of the thin client terminal 3. The virtual machine monitor 5 ends the process.

When the virtual machine monitor 5 determines that the device state of the external storage device 11 does not indicate the allocation-enabled state (NO in S503), the virtual machine monitor 5 checks whether the device state of the external storage device 11 indicates the release-enabled state (S504).

When the virtual machine monitor 5 determines that the device state of the external storage device 11 does not indicate the release-enabled state (NO in S504), the virtual machine monitor 5 outputs, to the cache operation unit 56, a request to stop storing the data of the recording medium 2 as cache data (S505). The cache operation unit 56 stops storing the data of the recording medium 2 and deletes the cache data being stored. The cache operation unit 56 outputs a notification of the stop of the storage of the cache data to the virtual machine monitor 5.

The virtual machine monitor 5 changes the access location of the virtual device 50 to “NULL” (S506). The virtual machine monitor 5 proceeds to step S509.

Meanwhile, when the virtual machine monitor 5 determines that the device state of the external storage device 11 indicates the release-enabled state (YES in S504), the virtual machine monitor 5 requests the unreflected data process to the cache operation unit 56.

The virtual machine monitor 5 enters the standby state, and the cache operation unit 56 executes the unreflected data process (S507). After the completion of the unreflected data process, the virtual machine monitor 5 checks whether the recording medium 2 is attached to the external storage device 11 (S508). When the virtual machine monitor 5 determines that the recording medium 2 is not attached to the external storage device 11 (NO in S508), the virtual machine monitor 5 proceeds to step S511.

Meanwhile, when the virtual machine monitor 5 determines that the recording medium 2 is attached to the external storage device 11 (YES in S508), the virtual machine monitor 5 proceeds to step S509.

When the access location of the virtual device 50 is changed to “NULL” (S506), or when the virtual machine monitor 5 determines that the recording medium 2 is attached to the external storage device 11 (YES in S508), the virtual machine monitor 5 outputs a notification for prompting the removal of the recording medium 2 to the virtual machine 4 (S509). The virtual machine 4 outputs the received notification to the output unit 31 of the thin client terminal 3.

The virtual machine monitor 5 checks whether the recording medium 2 is detached from the external storage device 11 (S510). The virtual machine monitor 5 receives, from the removable device group 6, information indicating whether the recording medium 2 is detached. When the virtual machine monitor 5 determines that the recording medium 2 is attached to the external storage device 11 (NO in S510), the virtual machine monitor 5 repeats the determination of step S510.

Meanwhile, when the virtual machine monitor 5 determines that the recording medium 2 is detached from the external storage device 11 (YES in S510), the virtual machine monitor 5 proceeds to step S511.

When the virtual machine monitor 5 determines that the recording medium 2 is not attached (NO in S508), or when the virtual machine monitor 5 determines that the recording medium 2 is detached (YES in S510), the virtual machine monitor 5 changes the device state of the external storage device 11 to the allocation-enabled state (S511).

The virtual machine monitor 5 outputs a request for deleting the cache data to the cache operation unit 56 (S512). The cache operation unit 56 deletes the cache data from the cache storage unit 57. The cache operation unit 56 outputs, to the virtual machine monitor 5, a notification of the deletion of the cache data from the cache storage unit 57.

The virtual machine monitor 5 outputs a notification of the release of the external storage device 11 to the virtual machine 4 (S513). The virtual machine 4 outputs the received notification to the output unit 31 of the thin client terminal 3. The virtual machine monitor 5 ends the process.

In this way, the information processing device 1 can release the external storage device 11 from the virtual machine 4 allocated to the external storage device 11 based on the release request from the virtual machine 4 allocated to the external storage device 11.

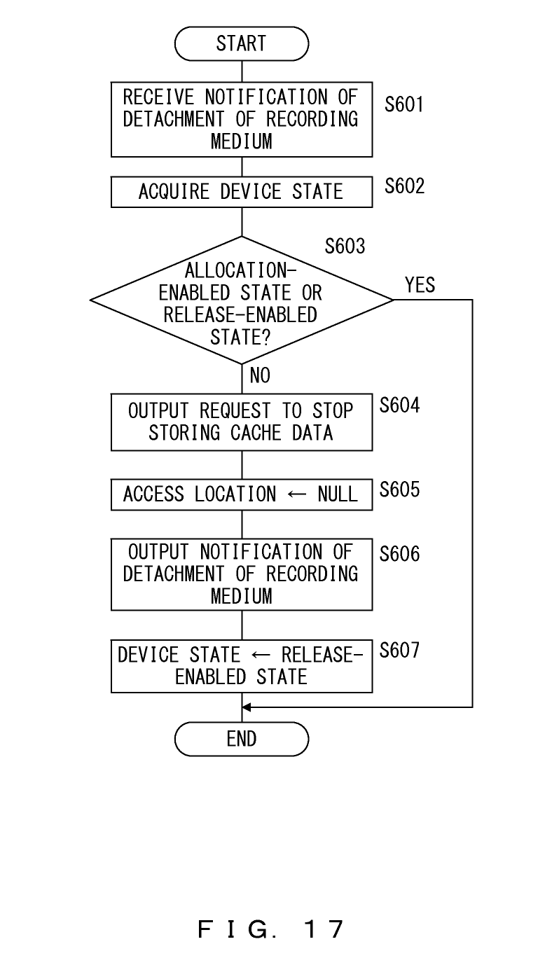

FIG. 17 is a flow chart showing a procedure of a control process when the recording medium 2 is detached. The external storage device 11 outputs a notification of the detachment of the recording medium 2 to the virtual machine monitor 5.

The virtual machine monitor 5 receives the notification of the detachment of the recording medium 2 (S601). The virtual machine monitor 5 acquires the device state of the external storage device 11 from the device state table 54 (S602).

The virtual machine monitor 5 checks whether the acquired device state indicates one of the allocation-enabled state and the release-enabled state (S603). When the virtual machine monitor 5 determines that the device state indicates one of the allocation-enabled state and the release-enabled state (YES in S603), the virtual machine monitor 5 ends the process.

Meanwhile, when the virtual machine monitor 5 determines that the device state does not indicate one of the allocation-enabled state and the release-enabled state (NO in S603), the virtual machine monitor 5 outputs, to the cache operation unit 56, a request to stop storing the data of the recording medium 2 as cache data (S604). The cache operation unit 56 stops storing the data of the recording medium 2 and deletes the cache data being stored. The cache operation unit 56 outputs a notification of the stop of the storage of the cache data to the virtual machine monitor 5.

The virtual machine monitor 5 changes the access location of the virtual device 50 to “NULL” (S605). The virtual machine monitor 5 outputs, to the virtual machine 4, a notification of the detachment of the recording medium 2 from the external storage device 11 (S606). The virtual machine 4 outputs the received notification to the output unit 31 of the thin client terminal 3. The virtual machine monitor 5 changes the device state of the external storage device 11 to the release-enabled state (S607). The virtual machine monitor 5 ends the process.

In this way, the information processing device 1 releases early the external storage device 11, from which the recording medium 2 is detached, from the virtual machine 4 of the allocated location. The information processing device 1 can quickly allocate the released external storage device 11 to the allocation-waiting virtual machine 4. The first embodiment has been described.

### Second Embodiment

An attribute of the recording medium 2 may be taken into account in the disclosed information processing device to allocate the external storage device 11 to the virtual machine 4. The content will be described as a second embodiment.

The configurations of the information processing device 1 and the peripheral equipment in the second embodiment are the same as the configurations of the information processing device 1 and the peripheral equipment in the first embodiment. Therefore, the same reference numerals are provided to the corresponding parts, and the description will not be repeated.

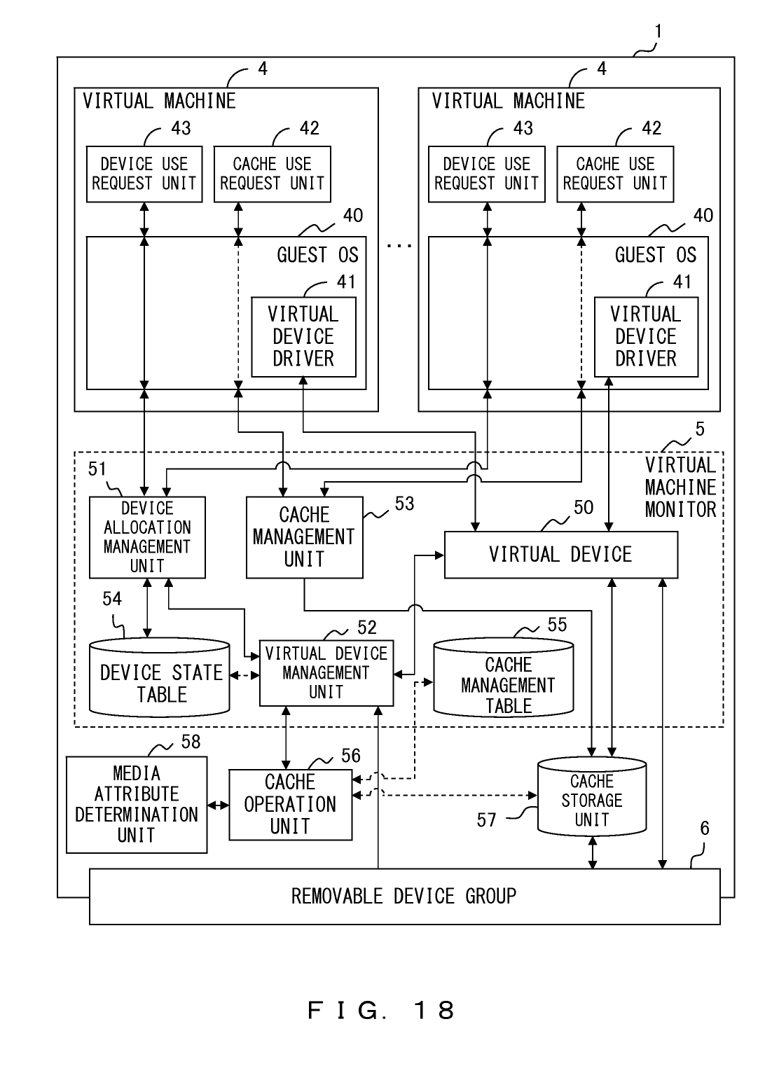

FIG. 18 is a functional block diagram of the information processing device 1 in the second embodiment. The information processing device 1 in the second embodiment has a function of a media attribute determination unit 58 in addition to the functions included in the information processing device 1 in the first embodiment. The media attribute determination unit 58 functions by operation of the CPU 10.

The media attribute determination unit 58 acquires an attribute of the recording medium 2 attached to the external storage device 11. An example of the attribute of the recording medium 2 includes that writing of data is impossible. The media attribute determination unit 58 outputs the attribute result to the cache operation unit 56.

When the attribute indicating that writing of data is impossible is received from the media attribute determination unit 58, the cache operation unit 56 outputs a notification of the storage of the cache data to the virtual device management unit 52.

The virtual device management unit 52 outputs the received notification to the device allocation management unit 51. The device allocation management unit 51 outputs a notification for prompting the removal of the recording medium 2 to the device use request unit 43. The device use request unit 43 outputs the received notification to the output unit 31 of the thin client terminal 3.

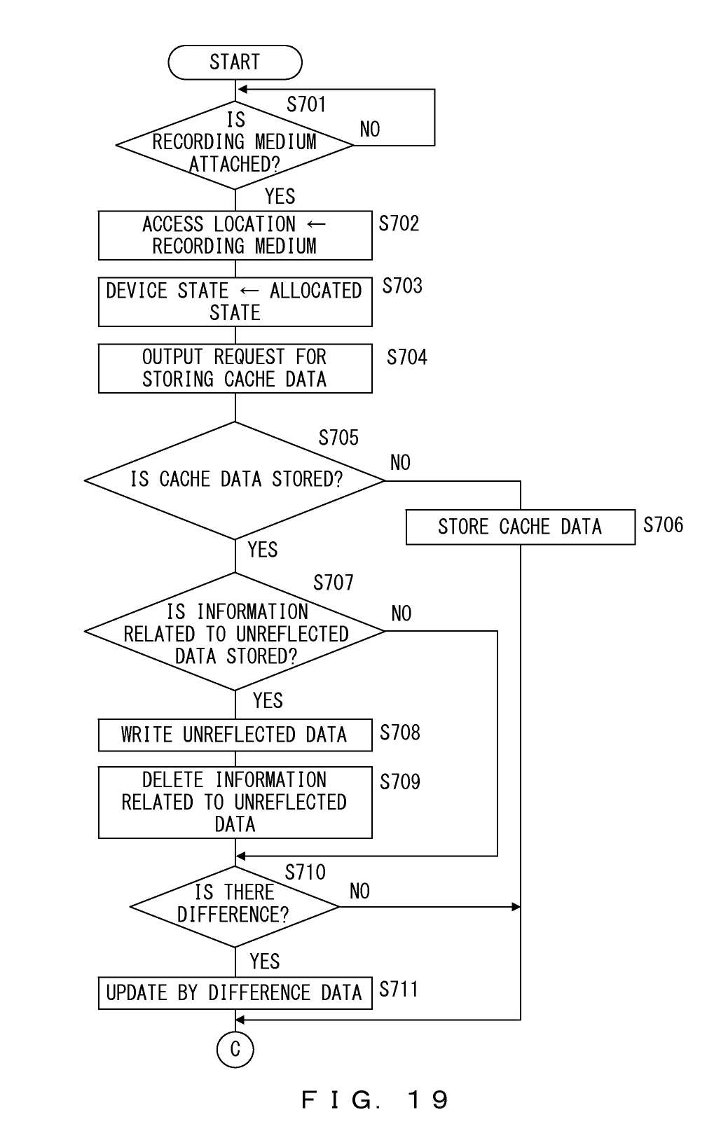

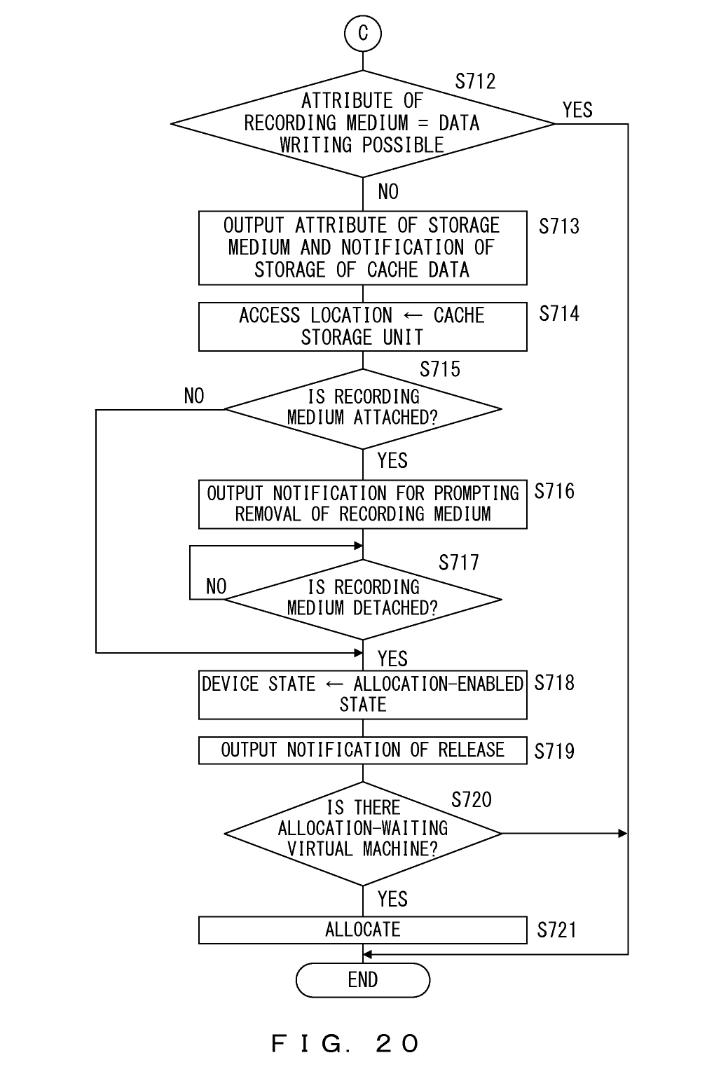

The information processing device 1 uses the resources above to execute the following process. FIGS. 19 and 20 are flow charts showing a procedure of a control process when the recording medium 2 with a predetermined attribute is attached. The external storage device 11 outputs information indicating whether the recording medium 2 is attached to the external storage device 11 to the virtual machine monitor 5.

The virtual machine monitor 5 checks whether the recording medium 2 is attached to the external storage device 11 (S701). When the virtual machine monitor 5 determines that the recording medium 2 is not attached to the external storage device 11 (NO in S701), the virtual machine monitor 5 repeats the determination of step S701.

Meanwhile, when the virtual machine monitor 5 determines that the recording medium 2 is attached to the external storage device 11 (YES in S701), the virtual machine monitor 5 changes the access location of the virtual device 50 to the recording medium 2 (S702). The virtual machine monitor 5 changes the device state of the external storage device 11 to the allocated state (S703). The virtual machine monitor 5 outputs a request for storing the data of the recording medium 2 as cache data to the cache operation unit 56 (S704).

The cache operation unit 56 checks whether the cache data is stored in the cache storage unit 57 (S705). When the cache operation unit 56 determines that the cache data is not stored in the cache storage unit 57 (NO in S705), the cache operation unit 56 stores the data of the recording medium 2 attached to the external storage device 11 in the cache storage unit 57 as cache data (S706). The cache operation unit 56 proceeds to step S712.

Meanwhile, when the cache operation unit 56 determines that the cache data is stored in the cache storage unit 57 (YES in S705), the cache operation unit 56 checks whether information related to the unreflected data is stored in the cache management table 55 (S707). When the cache operation unit 56 determines that the information related to the unreflected data is not stored in the cache management table 55 (NO in S707), the cache operation unit 56 proceeds to step S710.

Meanwhile, when the cache operation unit 56 determines that the information related to the unreflected data is stored in the cache management table 55 (YES in S707), the cache operation unit 56 writes the unreflected data to the attached recording medium 2 (S708). The cache operation unit 56 deletes the information related to the unreflected data finished with writing from the cache management table 55 (S709).

When the cache operation unit 56 determines that the information related to the unreflected data is not stored in the cache management table 55 (NO in S707), or when the information related to the unreflected data finished with writing is deleted from the cache management table 55 (S709), the cache operation unit 56 checks whether there is a difference between the data of the recording medium 2 and the cache data stored in the cache storage unit 57 (S710). When the cache operation unit 56 determines that there is no difference between the data of the recording medium 2 and the cache data stored in the cache storage unit 57 (NO in S710), the cache operation unit 56 proceeds to step S712.

Meanwhile, when the cache operation unit 56 determines that there is a difference between the data of the recording medium 2 and the cache data stored in the cache storage unit 57 (YES in S710), the cache operation unit 56 updates the cache data by difference data (S711). The cache operation unit 56 proceeds to step S712.

When the data of the recording medium 2 is stored in the cache storage unit 57 as cache data (S706), when the cache operation unit 56 determines that there is no difference between the data of the recording medium 2 and the cache data (NO in S710), or when the cache data is updated by the difference data (S711), the cache operation unit 56 outputs a request for determining the attribute of the recording medium 2 to the media attribute determination unit 58.

The media attribute determination unit 58 checks whether the attribute of the recording medium 2 indicates that writing of data is possible (S712). When the media attribute determination unit 58 determines that the attribute of the recording medium 2 indicates that writing of data is possible (YES in S712), the media attribute determination unit 58 ends the process.

Meanwhile, when the media attribute determination unit 58 determines that the attribute of the recording medium 2 indicates that writing of data is impossible (NO in S712), the media attribute determination unit 58 outputs the attribute of the recording medium 2 to the cache operation unit 56.

The cache operation unit 56 outputs the attribute of the recording medium 2 and a notification of the storage of the cache data to the virtual machine monitor 5 (S713).

The virtual machine monitor 5 changes the access location of the virtual device 50 to the cache storage unit 57 (S714). The virtual machine monitor 5 checks whether the recording medium 2 is attached to the external storage device 11 (S715). When the virtual machine monitor 5 determines that the recording medium 2 is detached from the external storage device 11 (NO in S715), the virtual machine monitor 5 proceeds to step S718.

Meanwhile, when the virtual machine monitor 5 determines that the recording medium 2 is attached to the external storage device 11 (YES in S715), the virtual machine monitor 5 outputs, to the virtual machine 4, a notification for prompting the removal of the recording medium 2 (S716). The virtual machine 4 outputs the received notification to the output unit 31 of the thin client terminal 3.

The virtual machine monitor 5 checks whether the recording medium 2 is detached from the external storage device 11 (S717). When the virtual machine monitor 5 determines that the recording medium 2 is attached to the external storage device 1 (NO in S717), the virtual machine monitor 5 repeats the determination of step S717.

Meanwhile, when the virtual machine monitor 5 determines that the recording medium 2 is detached from the external storage device 11 (YES in S717), the virtual machine monitor 5 proceeds to step S718.

When the virtual machine monitor 5 determines that the recording medium 2 is detached from the external storage device 11 (NO in S715 or YES in S717), the virtual machine monitor 5 changes the device state of the external storage device 11 to the allocation-enabled state (S718).

The virtual machine monitor 5 outputs a notification of the release of the external storage device 11 to the virtual machine 4 (S719). The virtual machine 4 outputs the received notification to the output unit 31 of the thin client terminal 3.

The virtual machine monitor 5 checks whether there is an allocation-waiting virtual machine 4 (S720). When the virtual machine monitor 5 determines that there is no allocation-waiting virtual machine 4 (NO in S720), the virtual machine monitor 5 ends the process.

Meanwhile, when the virtual machine monitor 5 determines that there is an allocation-waiting virtual machine 4 (YES in S720), the virtual machine monitor 5 allocates the external storage device 11 to the allocation-waiting virtual machine 4 (S721). The basic device allocation process is followed to allocate the external storage device 11. The virtual machine monitor 5 ends the process.

Other than the process above, the information processing device 1 executes the basic device allocation process, the unreflected data process, the basic control process when the recording medium 2 is attached, the basic reading/writing process for the recording medium 2, the basic device releasing process, and the control process when the recording medium 2 is detached. The procedures of the processes are the same as the procedures of the processes executed by the information processing device 1 in the first embodiment. Therefore, the same step numbers are provided to the corresponding procedures, and the description will not be repeated.

In this way, the information processing device 1 informs the end-user to detach the recording medium 2, in which writing of data is impossible, from the external storage device 11. The information processing device 1 quickly releases the external storage device 11, from which the recording medium 2 is detached, from the virtual machine 4 allocated to the external storage device 11. The second embodiment has been described.

### Third Embodiment

In the disclosed information processing device, whether the recording medium 2 can be used may be taken into account to allocate the external storage device 11 to the virtual machine 4. The content will be described as a third embodiment.

The configurations of the information processing device 1 and the peripheral equipment in the third embodiment are the same as the configurations of the information processing device 1 and the peripheral equipment in the first embodiment. Therefore, the same reference numerals are provided to the corresponding parts, and the description will not be repeated.

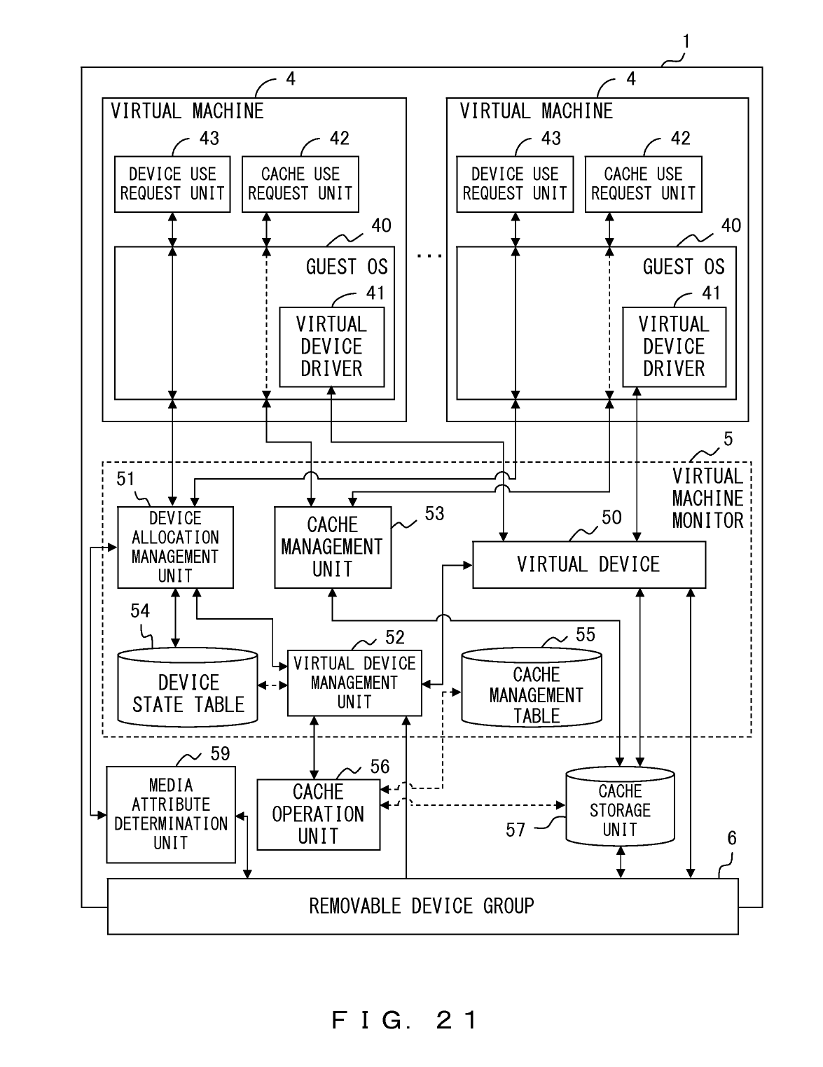

FIG. 21 is a functional block diagram of the information processing device 1 in the third embodiment. The information processing device 1 in the third embodiment has a function of a media attribute determination unit 59 in addition to the functions included in the information processing device 1 in the first embodiment. The media attribute determination unit 59 functions by operation of the CPU 10.

The media attribute determination unit 59 queries the external storage device 11 to acquire the attribute of the attached recording medium 2. An example of the attribute of the recording medium 2 in the third embodiment includes a case in which personal authentication is necessary to access the recording medium 2, and the recording medium 2 cannot be used because the authentication is not successful. The media attribute determination unit 59 outputs the attribute result to the device allocation management unit 51.

When an attribute indicating that the recording medium cannot be used is received from the media attribute determination unit 59, the device allocation management unit 51 outputs, to the device use request unit 43, a notification for prompting the removal of the recording medium 2. The device use request unit 43 outputs the received notification to the output unit 31 of the thin client terminal 3.

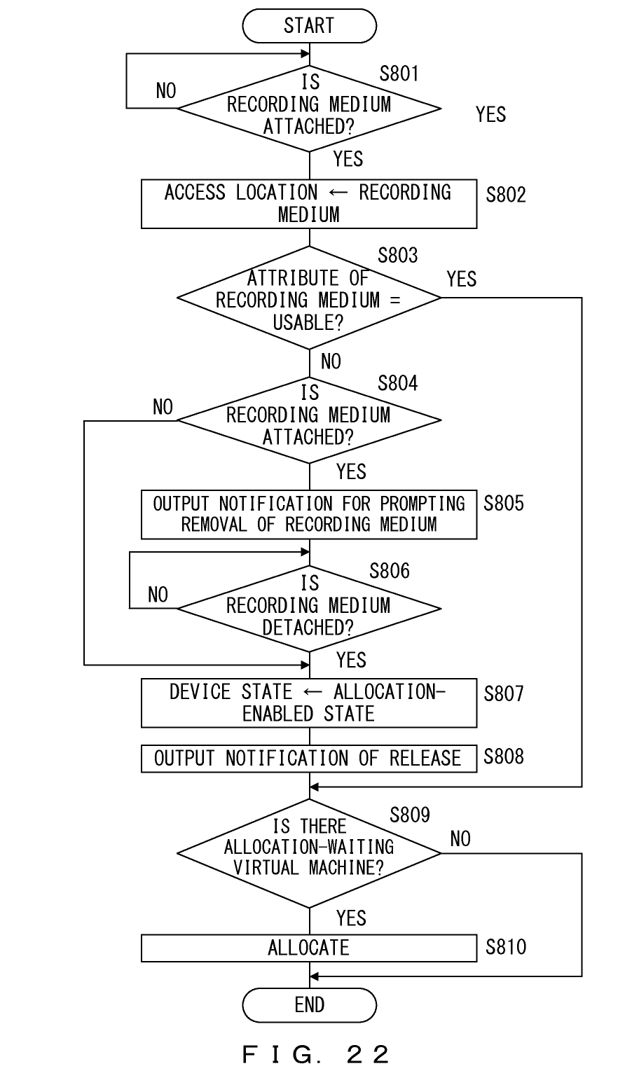

The information processing device 1 uses the resources above to execute the following process. FIG. 22 is a flow chart showing a procedure of a control process when the recording medium 2 with a predetermined attribute is attached. The external storage device 11 outputs, to the virtual machine monitor 5, information indicating whether the recording medium 2 is attached.

The virtual machine monitor 5 checks whether the recording medium 2 is attached to the external storage device 11 (S801). When the virtual machine monitor 5 determines that the recording medium 2 is not attached to the external storage device 11 (NO in S801), the virtual machine monitor 5 repeats the determination of step S801.

Meanwhile, when the virtual machine monitor 5 determines that the recording medium 2 is attached to the external storage device 11 (YES in S801), the virtual machine monitor 5 changes the access location of the virtual device 50 to the recording medium 2 (S802). The virtual machine monitor 5 outputs a request for determining the attribute of the recording medium 2 to the media attribute determination unit 59.

The media attribute determination unit 59 checks whether the attribute of the recording medium 2 is an attribute indicating that the recording medium 2 can be used (S803). When the media attribute determination unit 59 determines that the attribute of the recording medium 2 is an attribute indicating that the recording medium 2 can be used (YES in S803), the media attribute determination unit 59 proceeds to step S809 described later. However, the virtual machine monitor 5 and the cache operation unit 56 execute the process of steps S303 to S314 described above before the execution of step S809.

Meanwhile, when the media attribute determination unit 59 determines that the attribute of the recording medium 2 is an attribute indicating that the recording medium 2 cannot be used (NO in S803), the media attribute determination unit 59 outputs the attribute of the recording medium 2 to the virtual machine monitor 5. The virtual machine monitor 5 changes the access location of the virtual device 50 to “NULL”.

The virtual machine monitor 5 checks whether the recording medium 2 is attached to the external storage device 11 (S804). When the virtual machine monitor 5 determines that the recording medium 2 is detached from the external storage device 11 (NO in S804), the virtual machine monitor 5 proceeds to step S807.

Meanwhile, when the virtual machine monitor 5 determines that the recording medium 2 is attached to the external storage device 11 (YES in S804), the virtual machine monitor 5 outputs a notification for prompting the removal of the recording medium 2 to the virtual machine 4 (S805). The virtual machine 4 outputs the received notification to the output unit 31 of the thin client terminal 3.

The virtual machine monitor 5 checks whether the recording medium 2 is detached from the external storage device 11 (S806). When the virtual machine monitor 5 determines that the recording medium 2 is attached to the external storage device 11 (NO in S806), the virtual machine monitor 5 repeats the determination of step S806.

Meanwhile, when the virtual machine monitor 5 determines that the recording medium 2 is detached from the external storage device 11 (YES in S806), the virtual machine monitor 5 proceeds to step S807.

When the virtual machine monitor 5 determines that the recording medium 2 is detached from the external storage device 11 (NO in S804 or YES in S806), the virtual machine monitor 5 changes the device state of the external storage device 11 to the allocation-enabled state (S807). The virtual machine monitor 5 outputs a notification of the release of the external storage device 11 to the virtual machine 4 (S808). The virtual machine 4 outputs the received notification to the output unit 31 of the thin client terminal 3.

The virtual machine monitor 5 checks whether there is an allocation-waiting virtual machine 4 (S809). When the virtual machine monitor 5 determines that there is no allocation-waiting virtual machine 4 (NO in S809), the virtual machine monitor 5 ends the process.

Meanwhile, when the virtual machine monitor 5 determines that there is an allocation-waiting virtual machine 4 (YES in S809), the virtual machine monitor 5 allocates the external storage device 11 to the allocation-waiting virtual machine 4 (S810). The basic device allocation process is followed to allocate the external storage device 11. The virtual machine monitor 5 ends the process.

In this way, the information processing device 1 informs the end-user to detach the unusable recording medium 2 from the external storage device 11. The information processing device 1 releases the external storage device 11, from which the recording medium 2 is detached, from the virtual machine 4 allocated to the external storage device 11.

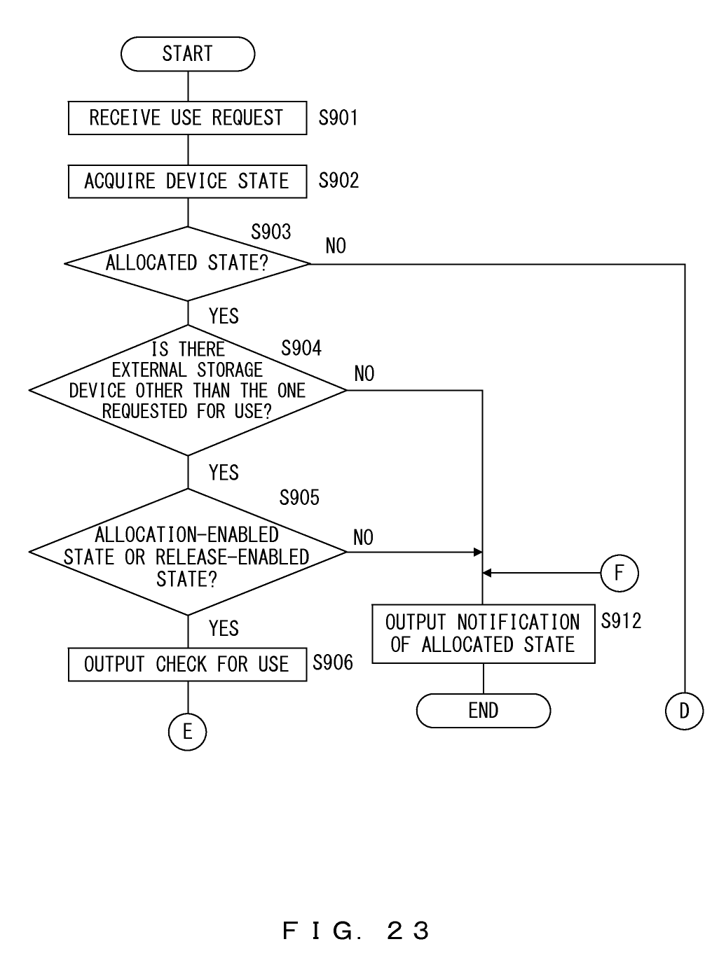

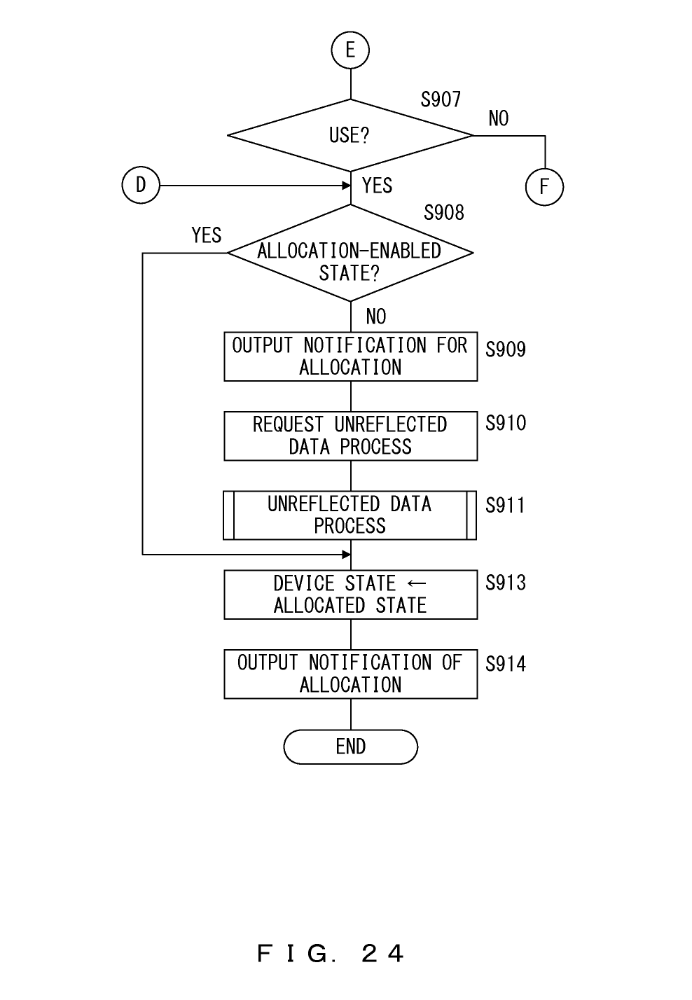

FIGS. 23 and 24 are flow charts showing a procedure of a device allocation process when there are a plurality of external storage devices 11. The end-user selects an arbitrary external storage device 11 through a device use request screen. The virtual machine 4 receives a use request of the selected external storage device 11. The virtual machine 4 outputs the use request of the external storage device 11 to the virtual machine monitor 5.

The virtual machine monitor 5 receives the use request outputted from the virtual machine 4 (S901). The virtual machine monitor 5 acquires the device state of the external storage device 11 from the device state table 54 (S902). The virtual machine monitor 5 checks whether the acquired device state indicates the allocated state (S903). When the virtual machine monitor 5 determines that the device state does not indicate the allocated state (NO in S903), the virtual machine monitor 5 proceeds to step S908.

Meanwhile, when the virtual machine monitor 5 determines that the device state indicates the allocated state (YES in S903), the virtual machine monitor 5 checks whether there is an external storage device 11 other than the external storage device 11 for which the use request is issued (S904). When the virtual machine monitor 5 determines that there is no external storage device 11 other than the external storage device 11 for which the use request is issued (NO in S904), the virtual machine monitor proceeds to step S912.

Meanwhile, when the virtual machine monitor 5 determines that there is an external storage device 11 other than the external storage device 11 for which the use request is issued (YES in S904), the virtual machine monitor 5 acquires the device state of the external storage device 11 from the device state table 54. The virtual machine monitor 5 checks whether the acquired device state indicates one of the allocation-enabled state and the release-enabled state (S905).

When the virtual machine monitor 5 determines that there is no external storage device 11 other than the external storage device 11 for which the use request is issued (NO in S904), when the virtual machine monitor 5 determines that all device states do not indicate the allocation-enabled state or the release-enabled state (NO in S905), or when the virtual machine monitor 5 determines that the response indicates not to use the external storage device 11 (NO in S907), the virtual machine monitor 5 adds, to the allocation-waiting virtual machine information, the name of the virtual machine that has issued the request and outputs a notification indicating that the external storage device 11 is in the allocated state to the virtual machine 4 that has issued the request (S912). The virtual machine monitor 5 ends the process.

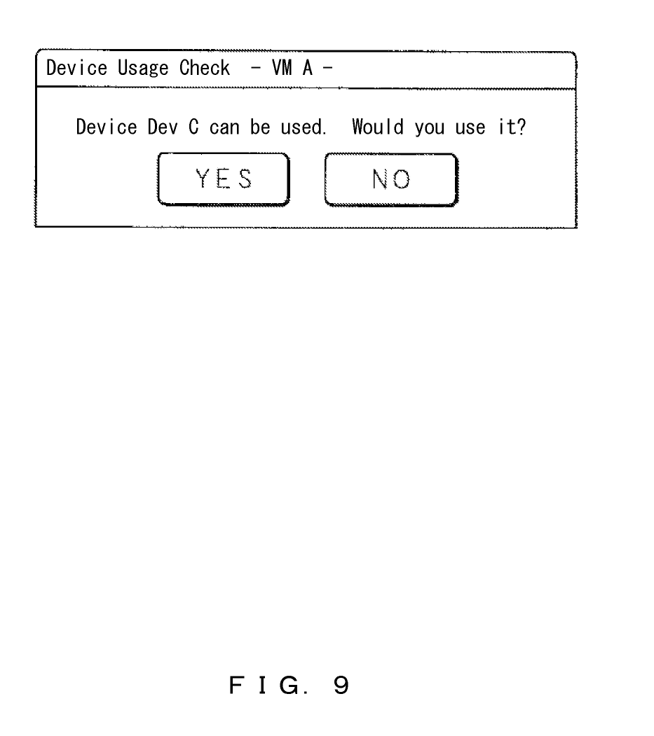

Meanwhile, when the virtual machine monitor 5 determines that the device states indicate one of the allocation-enabled state and the release-enabled state (YES in S905), the virtual machine monitor 5 outputs a check for using the external storage device 11 to the virtual machine 4 (S906). The virtual machine 4 outputs the received check to the output unit 31 of the thin client terminal 3. FIG. 9 is a diagram showing an example of display of a message of a device usage check. When the virtual machine 4 receives a response for the check through the input unit 30 of the thin client terminal 3, the virtual machine 4 outputs the received response to the virtual machine monitor 5.

The virtual machine monitor 5 checks whether the received response is a response for using the external storage device 11 (S907). When the virtual machine monitor 5 determines that the response is for not using the external storage device 11 (NO in S907), the virtual machine monitor 5 proceeds to step S912.

Meanwhile, when the virtual machine monitor 5 determines that the device state does not indicate the allocated state (NO in S903), or when the virtual machine monitor 5 determines that the response is for using the external storage device 11 (YES in S907), the virtual machine monitor 5 acquires the device state of the external storage device 11 and checks whether the device state indicates the allocation-enabled state (S908). When the virtual machine monitor 5 determines that the device state indicates the allocation-enabled state (YES in S908), the virtual machine monitor 5 proceeds to step S913.

Meanwhile, when the virtual machine monitor 5 determines that the device state does not indicate the allocation-enabled state (NO in S908), the virtual machine monitor 5 releases the external storage device 11 and outputs, to the virtual machine 4 allocated to the external storage device 11, a notification of new allocation to the virtual machine 4 that has issued the request (S909). The virtual machine 4 outputs the received notification to the output unit 31 of the thin client terminal 3.

The virtual machine monitor 5 requests the cache operation unit 56 for the unreflected data process (S910). The virtual machine monitor 5 enters the standby state, and the cache operation unit 56 executes the unreflected data process (S911). After the execution of the unreflected data process, the virtual machine monitor 5 proceeds to step S913.

When the virtual machine monitor 5 determines that it indicates the allocation-enabled state of the device state (YES in S908), or when the unreflected data process is executed (S911), the virtual machine monitor 5 changes the device state of the external storage device 11 to the allocated state (S913). The virtual machine monitor 5 outputs a notification of the allocation of the external storage device 11 to the virtual machine 4 that has issued the request (S914). The virtual machine monitor 5 ends the process.

Other than the process above, the information processing device executes the basic device allocation process, the unreflected data process, the basic control process when the recording medium 2 is attached, the basic recording/writing process for the recording medium 2, the basic device releasing process, and the control process when the recording medium 2 is detached. The procedures of the processes are the same as the processes executed by the information processing device 1 in the first embodiment. Therefore, the same step numbers are provided to the corresponding procedures, and the description will not be repeated.

In this way, when there is a use request from a virtual machine 4 other than the virtual machine 4 allocated to the external storage device 11, the information processing device 1 executes the unreflected data process and then allocates the external storage device 11 to the virtual machine 4 that has issued the use request. The third embodiment has been described.

### Fourth Embodiment

The disclosed information processing device may be configured to use the cache data already stored in the cache storage unit 57 to read and write data, instead of using the recording medium 2 attached to the external storage device 11. The disclosed information processing device may be configured to automatically delete the cache data with low use frequency from the cache storage unit 57. The content will be described as a fourth embodiment.

The configurations of the information processing device 1 and the peripheral equipment in the fourth embodiment are the same as the configurations of the information processing device 1 and the peripheral equipment in the first embodiment. Therefore, the same reference numerals are provided to the corresponding parts, and the description will not be repeated.

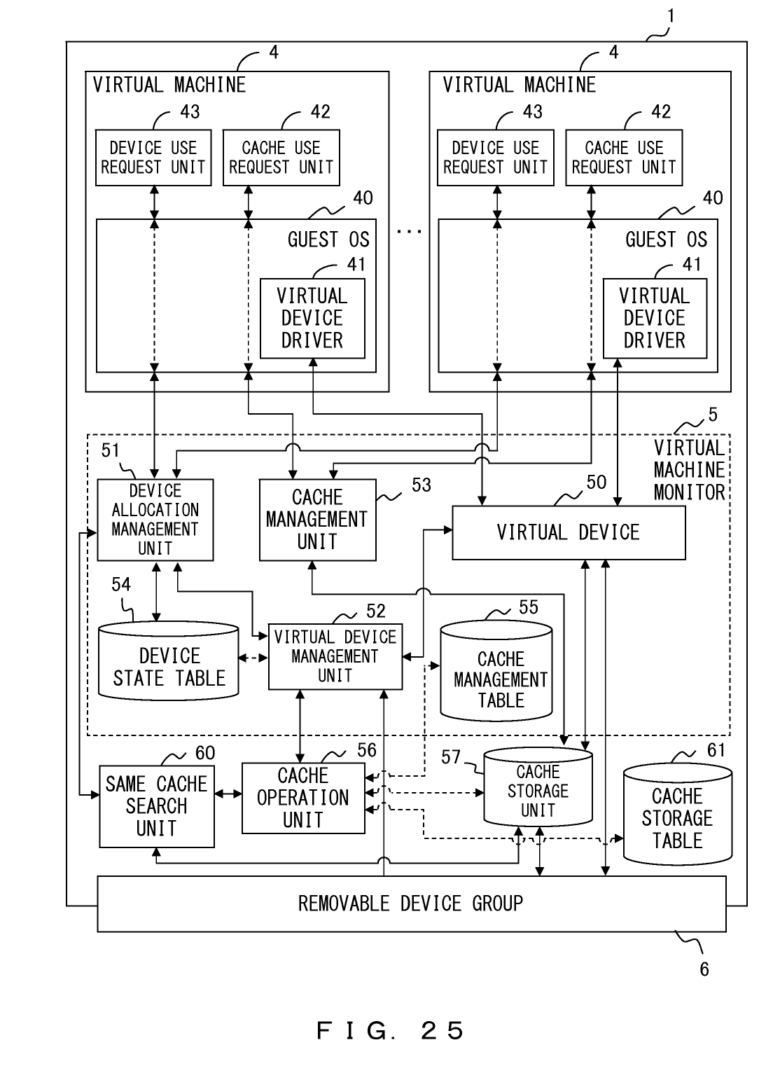

FIG. 25 is a functional block diagram of the information processing device 1 in the fourth embodiment. The information processing device 1 in the fourth embodiment has functions of a same cache search unit 60 and a cache storage table 61 in addition to the functions included in the information processing device 1 in the first embodiment. The same cache search unit 60 functions by operation of the CPU 10. The cache storage table 61 is stored in the auxiliary storage device 14.

The same cache search unit 60 checks whether the same data as in the content of the recording medium 2 attached to the external storage device 11 is already stored in the cache storage unit 57. An example of the same data already stored in the cache storage unit 57 includes an image file stored in the cache storage unit 57 according to a request of a virtual machine 4 other than the virtual machine 4 allocated to the external storage device 11, which is data with the same content as the content of the attached recording medium 2. The same cache search unit 60 outputs the result of checking to the cache operation unit 56.

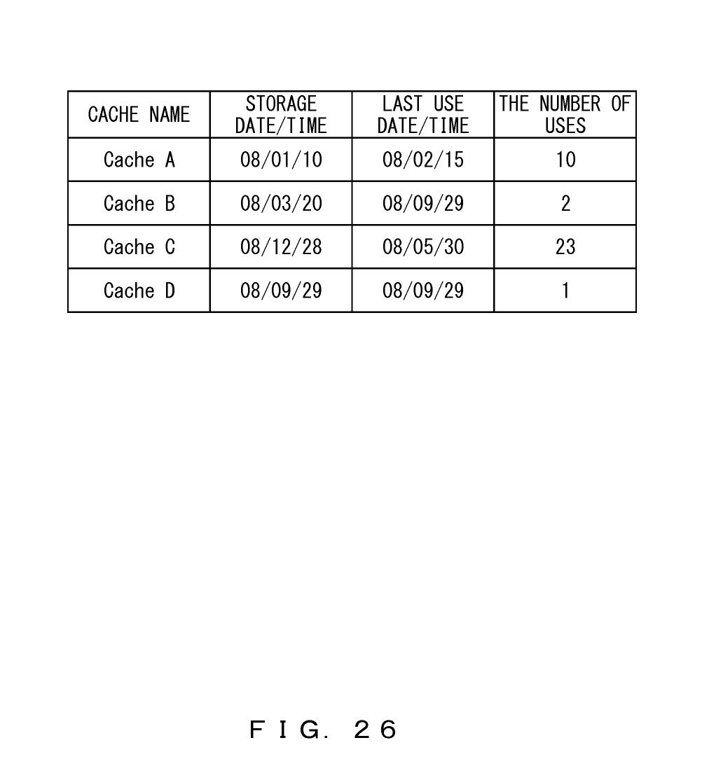

FIG. 26 is a diagram showing an example of format of the cache storage table 61. The cache storage table 61 stores a cache name, storage date/time, last use date/time, and the number of uses.

The cache name is information for identifying the cache data stored in the cache storage unit 57. The storage date/time denotes date/time of the storage of the data of the recording medium 2 in the cache storage unit 57 as cache data. The last use date/time denotes the latest date/time of access to the cache data stored in the cache storage unit 57. The number of uses denotes the number of accesses to the cache data stored in the cache storage unit 57.

The cache management unit 53 checks whether a storage period of the cache data stored in the cache storage unit 57 is beyond a predetermined period. The cache management unit 53 determines whether the capacity of the cache data is over the storage capacity of the cache storage unit 57. The cache management unit 53 compares the use frequency of the cache data stored in the cache storage unit 57. The cache management unit 53 deletes the cache data stored for a predetermined period or the cache data with low use frequency from the cache storage unit 57.

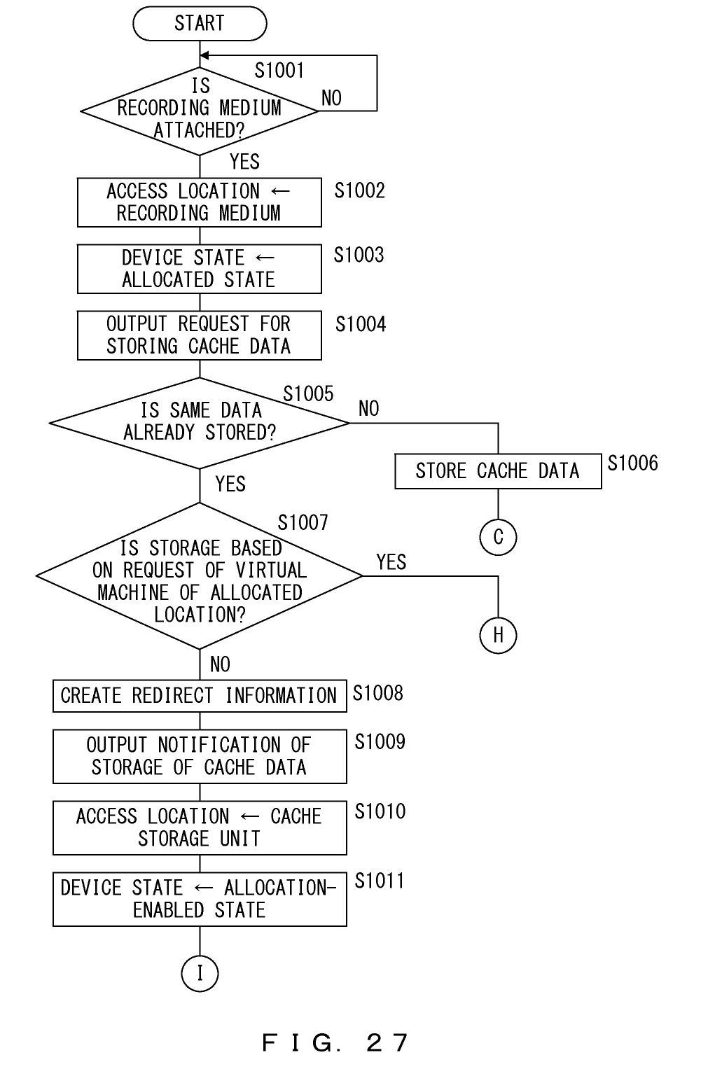

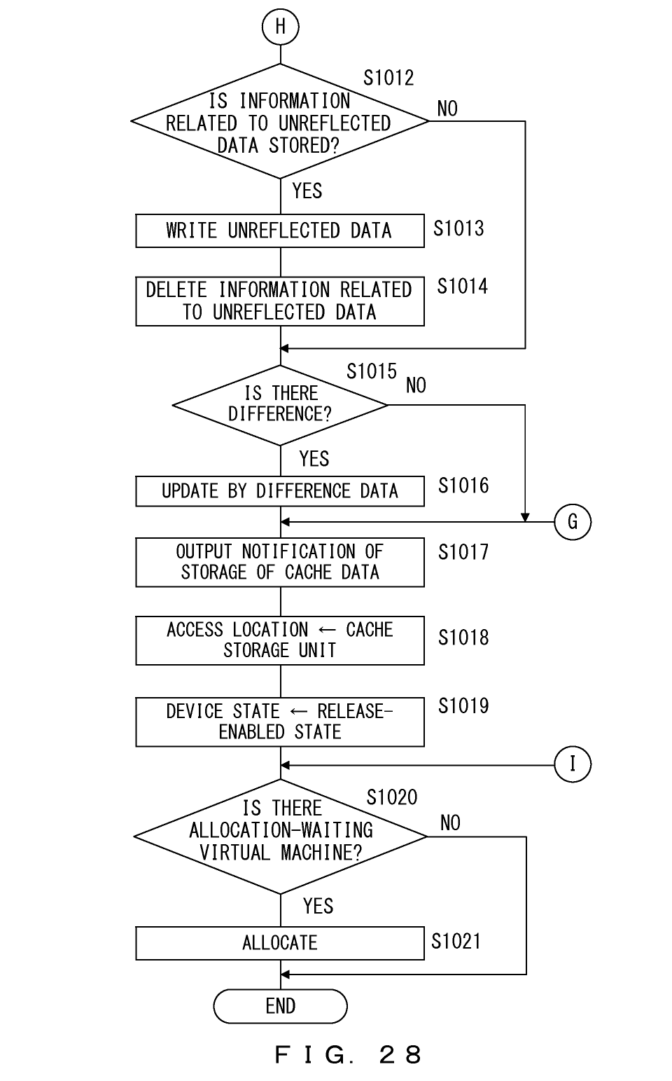

The information processing device 1 uses the resources above to execute the following process. FIGS. 27 and 28 are flow charts showing a procedure of a control process when a plurality of virtual machines 4 share the cache data stored in the cache storage unit 57. The external storage device 11 outputs, to the virtual machine monitor 5, information indicating whether the recording medium 2 is attached.

The virtual machine monitor 5 checks whether the recording medium 2 is attached to the external storage device 11 (S1001). When the virtual machine monitor 5 determines that the recording medium 2 is not attached to the external storage device 11 (NO in S1001), the virtual machine monitor 5 repeats the determination of step S1001.

Meanwhile, when the virtual machine monitor 5 determines that the recording medium 2 is attached to the external storage device 11 (YES in S1001), the virtual machine monitor 5 changes the access location of the virtual device 50 to the recording medium 2 (S1002). The virtual machine monitor 5 changes the device state of the external storage device 11 to the allocated state (S1003).

The virtual machine monitor 5 outputs a request for storing the cache data to the cache operation unit 56 (S1004). The cache operation unit 56 requests the same cache search unit 60 to check whether the same data as the data of the recording medium 2 attached to the external storage device 11 is already stored in the cache storage unit 57.

The same cache search unit 60 checks whether the same data is already stored in the cache storage unit 57 (S1005). When the same cache search unit 60 determines that the same data is not stored in the cache storage unit 57 (NO in S1005), the same cache search unit 60 outputs a determination result to the cache operation unit 56.

The cache operation unit 56 stores the data of the recording medium 2 attached to the external storage device 11 in the cache storage unit 57 as cache data (S1006). The cache operation unit 56 proceeds to step S1017.

When the same cache search unit 60 determines that the same data is stored in the cache storage unit 57 (YES in S1005), the same cache search unit 60 checks whether the stored data is stored based on a request of the virtual machine allocated to the external storage device 11 (S1007). When the same cache search unit 60 determines that the stored data is stored based on a request of a virtual machine 4 other than the virtual machine 4 allocated to the external storage device 11 (NO in S1007), the same cache search unit 60 outputs the determination result to the cache operation unit 56.

The cache operation unit 56 creates redirect information (S1008). The redirect information is information related to cache data that is a target of reading and writing and that is already stored in the cache storage unit 57. The cache operation unit 56 outputs a notification of the storage of the cache data to the virtual machine monitor 5 (S1009).

The virtual machine monitor 5 changes the access location of the virtual device 50 to the cache storage unit 57 (S1010). The virtual machine monitor 5 changes the device state of the external storage device 11 to the allocation-enabled state (S1011). The virtual machine monitor 5 proceeds to step S1020.

Meanwhile, when the same cache search unit 60 determines that the stored data is stored based on the request of the virtual machine 4 allocated to the external storage device 11 in step S1007 (YES in S1007), the same cache search unit 60 outputs the determination result to the cache operation unit 56.

The cache operation unit 56 checks whether information related to the unreflected data is stored in the cache management table 55 (S1012). When the cache operation unit 56 determines that the information related to the unreflected data is not stored in the cache management table 55 (NO in S1012), the cache operation unit 56 proceeds to step S1015.

Meanwhile, when the cache operation unit 56 determines that the information related to the unreflected data is stored in the cache management table 55 (YES in S1012), the cache operation unit 56 writes the unreflected data to the attached recording medium 2 (S1013). The cache operation unit 56 deletes the information related to the unreflected data finished with writing from the cache management table 55 (S1014).

When the cache operation unit 56 determines that the information related to the unreflected data is not stored in the cache management table 55 (NO in S1012), or when the information related to the unreflected data finished with writing is deleted from the cache management table 55 (S1014), the cache operation unit 56 checks whether there is a difference between the data of the recording medium 2 and the cache data stored in the cache storage unit 57 (S1015). When the cache operation unit 56 determines that there is no difference between the data of the recording medium 2 and the cache data stored in the cache storage unit 57 (NO in S1015), the cache operation unit 56 proceeds to step S1017.

Meanwhile, when the cache operation unit 56 determines that there is a difference between the data of the recording medium 2 and the cache data stored in the cache storage unit 57 (YES in S1015), the cache operation unit 56 updates the cache data by difference data (S1016). The cache operation unit 56 proceeds to step S1017.

When the data of the recording medium 2 is stored in the cache storage unit 57 (S1006), when the cache operation unit 56 determines that there is no difference between the data of the recording medium 2 and the cache data stored in the cache storage unit 57 (NO in S1015), or when the cache data is updated by the difference data (S1016), the cache operation unit 56 outputs a notification of the storage of the cache data to the virtual machine monitor 5 (S1017).

The virtual machine monitor 5 changes the access location of the virtual device 50 to the cache storage unit 57 (S1018). The virtual machine monitor 5 changes the device state of the external storage device 11 to the release-enabled state (S1019). The virtual machine monitor 5 proceeds to step S1020.

When the device state is changed to the allocation-enabled state (S1011), or when the device state is changed to the release-enabled state (S1019), the virtual machine monitor 5 checks whether there is an allocation-waiting virtual machine 4 (S1020). When the virtual machine monitor 5 determines that there is no allocation-waiting virtual machine 4 (NO in S1020), the virtual machine monitor 5 ends the process.

Meanwhile, when the virtual machine monitor 5 determines that there is an allocation-waiting virtual machine 4 (YES in S1020), the virtual machine monitor 5 allocates the external storage device 11 to the allocation-waiting virtual machine 4 (S1021). The basic device allocation process is followed to allocate the external storage device 11. The virtual machine monitor 5 ends the process.

In this way, when the process for storing the data of the recording medium 2 can be skipped, the information processing device 1 releases the external storage device 11 from the virtual machine 4 allocated to the external storage device 11 early.

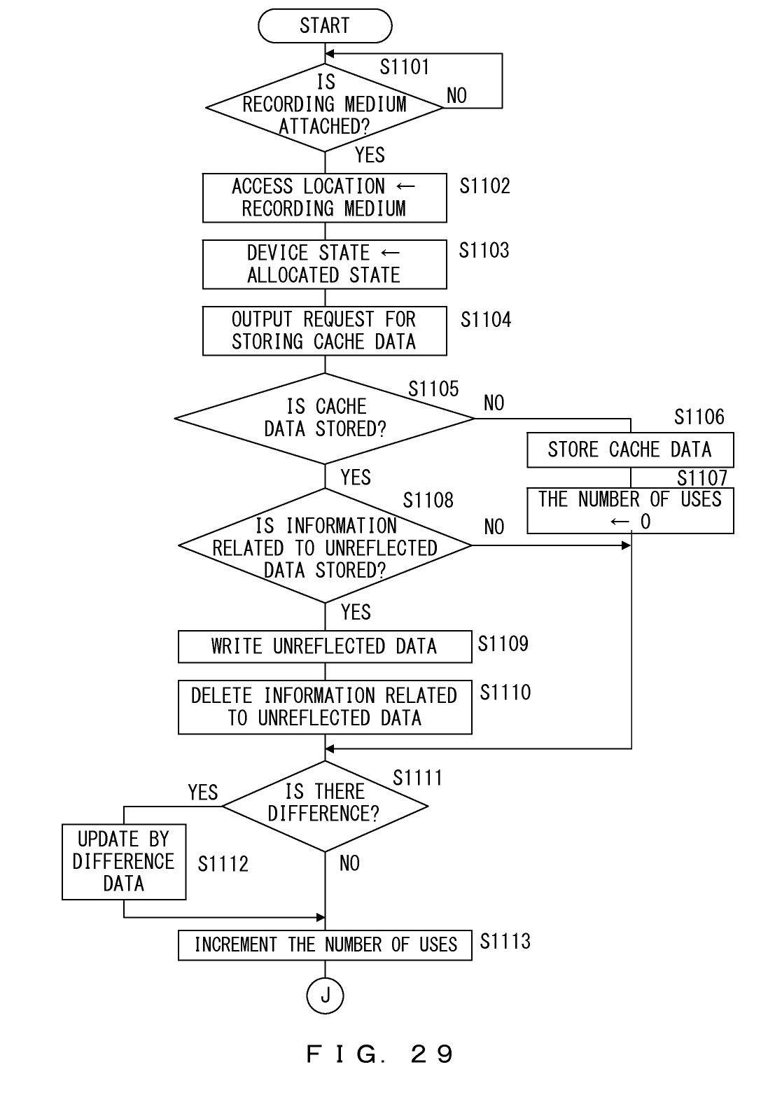

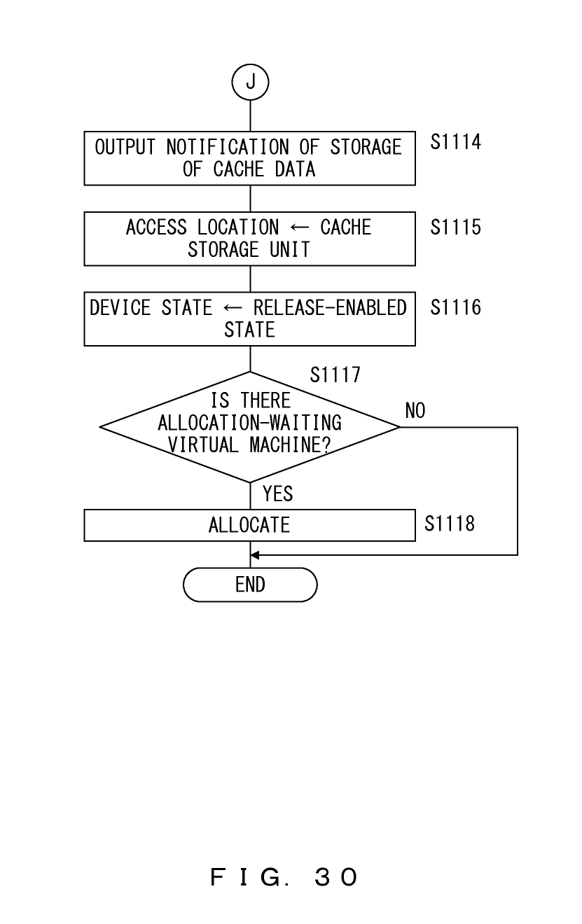

FIGS. 29 and 30 are flow charts showing a procedure of a control process when the recording medium 2 is attached. The external storage device 11 outputs, to the virtual machine monitor 5, information indicating whether the recording medium 2 is attached.

The virtual machine monitor 5 checks whether the recording medium 2 is attached to the external storage device 11 (S1101). When the virtual machine monitor 5 determines that the recording medium 2 is not attached to the external storage device 11 (NO in S1101), the virtual machine monitor 5 repeats the determination of step S1101.

Meanwhile, when the virtual machine monitor 5 determines that the recording medium 2 is attached to the external storage device 11 (YES in S1101), the virtual machine monitor 5 changes the access location of the virtual device 50 to the recording medium 2 (S1102). The virtual machine monitor 5 changes the device state of the external storage device 11 to the allocated state (S1103). The virtual machine monitor 5 outputs a request for storing the cache data to the cache operation unit 56 (S1104).

The cache operation unit 56 checks whether the cache data is stored in the cache storage unit 57 (S1105). When the cache operation unit 56 determines that the cache data is not stored in the cache storage unit 57 (NO in S1105), the cache operation unit 56 stores the data of the recording medium 2 attached to the external storage device 11 in the cache storage unit 57 as cache data (S1106).

The cache operation unit 56 stores the storage date/time and the number of uses of the cache data in the cache storage table 61. The cache operation unit 56 provides 0 to the number of uses (S1107). The cache operation unit 56 proceeds to step S1111.

Meanwhile, when the cache operation unit 56 determines that the cache data is stored in the cache storage unit 57 (YES in S1105), the cache operation unit 56 checks whether information related to the unreflected data is stored in the cache management table 55 (S1108). When the cache operation unit 56 determines that the information related to the unreflected data is not stored in the cache management table 55 (NO in S1108), the cache operation unit 56 proceeds to step S1111.

Meanwhile, when the cache operation unit 56 determines that the information related to the unreflected data is stored in the cache management table 55 (YES in S1108), the cache operation unit 56 writes the unreflected data to the attached recording medium 2 (S1109). The cache operation unit 56 deletes the information related to the unreflected data finished with writing from the cache management table 55 (S1110). The cache operation unit 56 proceeds to step S1111.

When 0 is provided to the number of uses of the cache storage table 61 (S1107), when the cache operation unit 56 determines that the information related to the unreflected data is not stored (NO in S1108), or when the information related to the unreflected data finished with writing is deleted (S1110), the cache operation unit 56 checks whether there is a difference between the data of the recording medium 2 and the cache data stored in the cache storage unit 57 (S1111).

When the cache operation unit 56 determines that there is a difference between the data of the recording medium 2 and the cache data stored in the cache storage unit 57 (YES in S1111), the cache operation unit 56 updates the cache data by difference data (S1112). The cache operation unit 56 proceeds to step S1113.

Meanwhile, when the cache operation unit 56 determines that there is no difference between the data of the recording medium 2 and the cache data stored in the cache storage unit 57 (NO in S1111), the cache operation unit 56 proceeds to step S1113.

When the cache data is updated by the difference data (S1112), or when the cache operation unit 56 determines that there is no difference between the data of the recording medium 2 and the cache data stored in the cache storage unit 57 (NO in S1111), the cache operation unit 56 stores the last use date/time of the cache data in the cache storage table 61. The cache operation unit 56 increments the number of uses (S1113). The cache operation unit 56 outputs a notification of the storage of the cache data to the virtual machine monitor 5 (S1114).

The virtual machine monitor 5 changes the access location of the virtual device 50 to the cache storage unit 57 (S1115). The virtual machine monitor 5 changes the device state of the external storage device 11 to the release-enabled state (S1116). The virtual machine monitor checks whether there is an allocation-waiting virtual machine 4 (S1117). When the virtual machine monitor 5 determines that there is no allocation-waiting virtual machine 4 (NO in S1117), the virtual machine monitor 5 ends the process.

Meanwhile, when the virtual machine monitor 5 determines that there is an allocation-waiting virtual machine 4 (YES in S1117), the virtual machine monitor 5 allocates the external storage device 11 to the allocation-waiting virtual machine 4 (S1118). The basic device allocation process is followed to allocate the external storage device 11. The virtual machine monitor 5 ends the process.

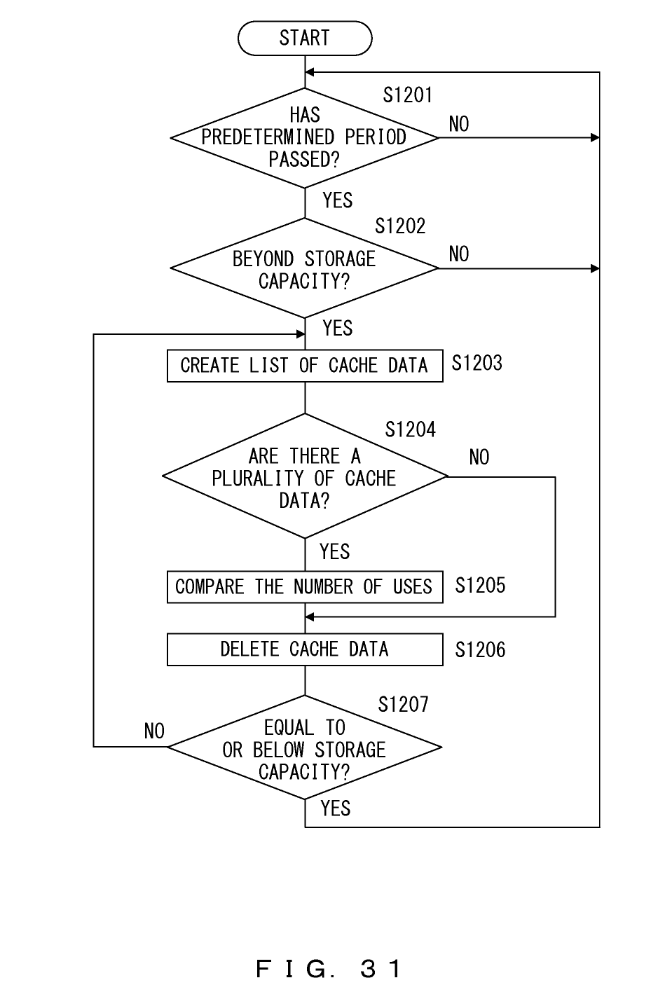

FIG. 31 is a flow chart showing a procedure of a deletion process of the cache data. The virtual machine monitor 5 checks whether the storage period of the cache data stored in the cache storage unit 57 is beyond a predetermined period (S1201). When the virtual machine monitor 5 determines that the storage period is not beyond the predetermined period (NO in S1201), the virtual machine monitor 5 repeats the determination of step S1201.

Meanwhile, when the virtual machine monitor 5 determines that the storage period is beyond the predetermined period (YES in S1201), the virtual machine monitor 5 checks whether the capacity of the cache data is over the storage capacity of the cache storage unit 57 (S1202). When the virtual machine monitor 5 determines that the capacity of the cache data is under the storage capacity (NO in S1202), the virtual machine monitor 5 returns to step S1201 and repeats the process.

Meanwhile, when the virtual machine monitor 5 determines that the capacity of the cache data is over the storage capacity (YES in S1202), the virtual machine monitor 5 creates a list (not shown) of the cache data in which the storage period is beyond the predetermined period (S1203). The virtual machine monitor 5 creates a list including the cache data lined up in descending order of the elapsed period.

The virtual machine monitor 5 checks whether there are a plurality of cache data in the list (S1204). When the virtual machine monitor 5 determines that there is one cache datum in the list (NO in S1204), the virtual machine monitor 5 determines that the cache datum is to be deleted and proceeds to step S1206.

Meanwhile, when the virtual machine monitor 5 determines that there are a plurality of cache data in the list (YES in S1204), the virtual machine monitor 5 compares the number of uses of the cache data (S1205). The virtual machine monitor 5 determines the cache datum with the minimum number of uses is to be deleted and proceeds to step S1206.

When the virtual machine monitor 5 determines the cache datum to be deleted, the virtual machine monitor 5 deletes the cache datum to be deleted from the cache storage unit 57 (S1206). After the deletion, the virtual machine monitor 5 checks whether the capacity of the cache data is equal to or below the storage capacity of the cache storage unit 57 (S1207).

When the virtual machine monitor 5 determines that the capacity of the cache data is equal to or below the storage capacity of the cache storage unit 57 (YES in S1207), the virtual machine monitor 5 returns to step S1201 and repeats the process.

Meanwhile, when the virtual machine monitor 5 determines that the capacity of the cache data is over the storage capacity of the cache storage unit 57 (NO in S1207), the virtual machine monitor 5 returns to step S1203 and again creates a list of the cache data in which the storage period is beyond the predetermined period.

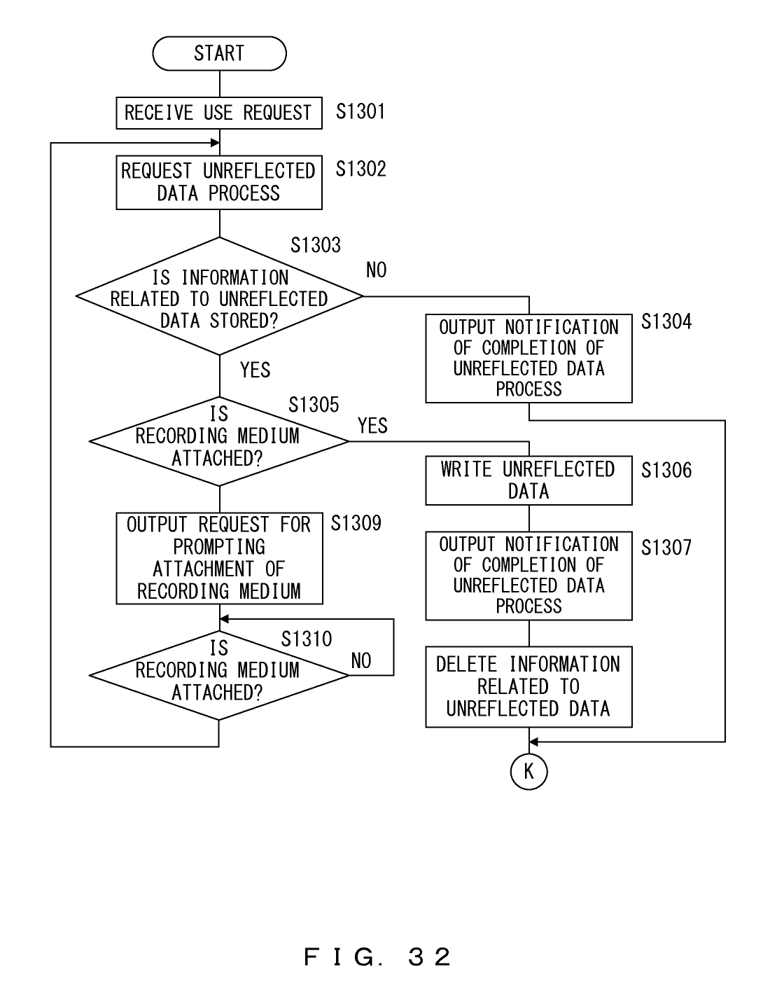

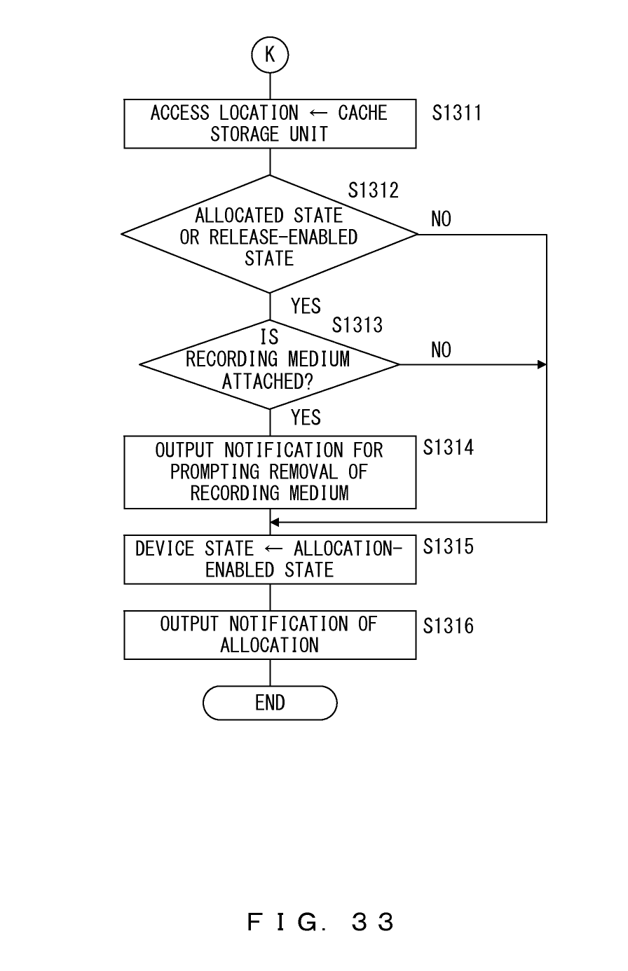

FIGS. 32 and 33 are flow charts showing a procedure of an allocation process of cache data stored in the cache storage unit 57. The virtual machine 4 receives a use request of the cache data stored in the cache storage unit 57. The virtual machine 4 outputs the use request to the virtual machine monitor 5.

The virtual machine monitor 5 receives the use request from the virtual machine 4 (S1301). The virtual machine monitor 5 requests the cache operation unit 56 for the unreflected data process (S1302).

The cache operation unit 56 checks whether information related to the unreflected data is stored in the cache management table 55 (S1303). When the cache operation unit 56 determines that the information related to the unreflected data is not stored in the cache management table 55 (NO in S1303), the cache operation unit 56 outputs a notification of the completion of the unreflected data process to the virtual machine monitor 5 (S1304). The virtual machine monitor 5 proceeds to step S1311.

Meanwhile, when the cache operation unit 56 determines that the information related to the unreflected data is stored in the cache management table 55 (YES in S1303), the cache operation unit 56 checks whether the recording medium 2 is attached to the external storage device 11 (S1305).

When the cache operation unit 56 determines that the recording medium 2 is attached to the external storage device 11 (YES in S1305), the cache operation unit 56 writes the unreflected data to the attached recording medium 2 (S1306). The cache operation unit 56 outputs a notification of the completion of the unreflected data process to the virtual machine monitor 5 (S1307). The cache operation unit 56 deletes the information related to the unreflected data finished with writing from the cache management table 55 (S1308). The virtual machine monitor 5 proceeds to step S1311.

Meanwhile, when the cache operation unit 56 determines that the recording medium 2 is not attached to the external storage device 11 in step S1305 (NO in S1305), the cache operation unit 56 outputs, to the virtual machine 4, information related to the recording medium 2 that should be attached and a notification for prompting the attachment of the recording medium 2 (S1309). The virtual machine 4 outputs the received notification to the output unit 31 of the thin client terminal 3.

The cache operation unit 56 checks whether the recording medium 2 is attached (S1310). When the cache operation unit 56 determines that the recording medium 2 is not attached (NO in S1310), the cache operation unit 56 repeats the determination of step S1310.

Meanwhile, when the cache operation unit 56 determines that the recording medium 2 is attached (YES in S1310), the cache operation unit 56 returns to step S1302 and requests the unreflected data process again.

When the cache operation unit 56 outputs a notification of the completion of the unreflected data process (S1304), or when the cache operation unit 56 deletes the information related to the unreflected data finished with writing (S1308), the virtual machine monitor updates the access location of the external storage device 11 to the cache storage unit 57 (S1311).

The virtual machine monitor 5 checks whether the device state of the external storage device 11 indicates one of the allocated state and the release-enabled state (S1312). When the virtual machine monitor 5 determines that the device state of the external storage device 11 does not indicate one of the allocated state and the release-enabled state (NO in S1312), the virtual machine monitor 5 proceeds to step S1315.

Meanwhile, when the virtual machine monitor 5 determines that the device state of the external storage device 11 indicates one of the allocated state and the release-enabled state (YES in 1312), the virtual machine monitor 5 checks whether the recording medium 2 is attached to the external storage device 11 (S1313). When the virtual machine monitor 5 determines that the recording medium 2 is not attached to the external storage device 11 (NO in S1313), the virtual machine monitor 5 proceeds to step S1315.

Meanwhile, when the virtual machine monitor 5 determines that the recording medium 2 is attached to the external storage device 11 (YES in S1313), the virtual machine monitor 5 outputs a notification for prompting the removal of the recording medium 2 to the virtual machine 4 (S1314). The virtual machine monitor 5 proceeds to step S1315.

When the virtual machine monitor 5 determines that the device state does not indicate one of the allocated state and the release-enabled state (NO in S1312), when the virtual machine monitor 5 determines that the recording medium 2 is not attached (NO in S1313), and when a screen for prompting the removal of the recording medium 2 is outputted (S1314), the virtual machine monitor 5 changes the device state of the external storage device 11 to the allocation-enabled state (S1315). The virtual machine monitor 5 outputs a notification of the allocation of the external storage device 1 to the virtual machine 4 (S1316). The virtual machine monitor 5 ends the process.

Other than the process above, the information processing device 1 executes the basic device allocation process, the unreflected data process, the basic control process when the recording medium 2 is attached, the basic reading/writing process for the recording medium 2, the basic device releasing process, and the control process when the recording medium 2 is detached. The procedures of the processes are the same as the procedures of the processes executed by the information processing device 1 in the first embodiment. Therefore, the same step numbers are provided to the corresponding procedures, and the description will not be repeated.

Redirect information is created when the virtual machine 4 allocated to the external storage device 11 does not store the data of the recording medium 2, and the cache data stored in the cache storage unit 57 is read and written based on a request of a virtual machine 4 other than the virtual machine 4 allocated to the external storage device 11. Therefore, the virtual machine 4 allocated to the external storage device 11 loses the target of reading and writing when the cache data is deleted.

Consequently, when deleting the cache data from the cache storage unit 57, the virtual machine monitor 5 checks whether the direct information is created. When the virtual machine monitor 5 determines that the redirect information is created, the virtual machine monitor 5 copies the cache data to the cache storage unit 57. Subsequently, the virtual machine 4 of the allocated location reads and writes the copied cache data.

In this way, the information processing device 1 is configured to read and write data by using the cache data already stored in the cache storage unit 57, instead of in the recording medium 2 attached to the external storage device 11. Therefore, the external storage device 11 can be released early from the virtual machine 4 allocated to the external storage device 11. As a result, the information processing device 1 can efficiently allocate the external storage device 11 to the allocation-waiting virtual machine 4. Since the information processing device automatically deletes the cache data with low use frequency from the cache storage unit 57, the operation load of the manager can be reduced. The fourth embodiment has been described.

### Fifth Embodiment

The disclosed information processing device may be configured to release the cache data from the virtual machine 4 when a cache no-access state of not receiving a request of reading and writing of the cache data stored in the cache storage unit 57 from the virtual machine 4 is continuing for a predetermined time. The content will be described as a fifth embodiment.

The configurations of the information processing device 1 and the peripheral equipment in the fifth embodiment are the same as the configurations of the information processing device 1 and the peripheral equipment in the first embodiment. Therefore, the same reference numerals are provided to the corresponding parts, and the description will not be repeated.

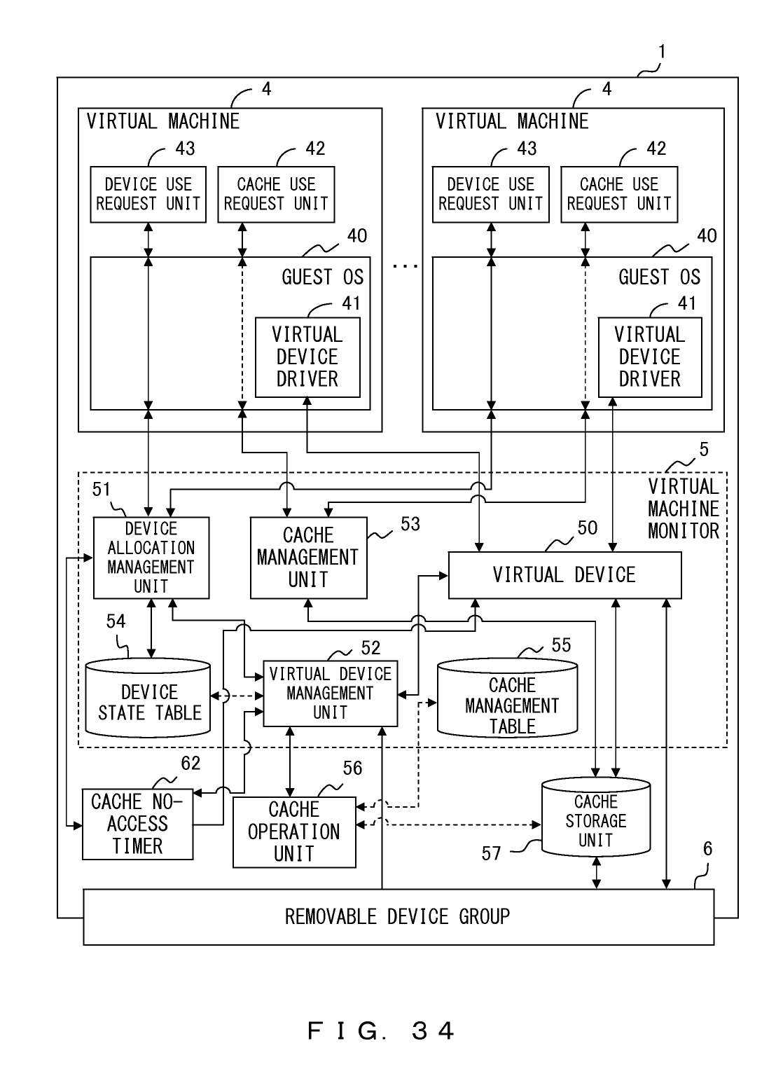

FIG. 34 is a functional block diagram of the information processing device 1 in the fifth embodiment. The information processing device 1 in the fifth embodiment has a function of a cache no-access timer 62 in addition to the functions included in the information processing device 1 in the first embodiment. The cache no-access timer 62 functions by operation of the CPU 10.

The cache management unit 53 monitors access to the cache data stored in the cache storage unit 57. The cache management unit 53 uses the cache no-access timer 62 to keep the time.

When the cache management unit 53 determines that the cache no-access state is continuing for a predetermined time, the cache management unit 53 outputs a request for changing the access location of the virtual device 50 to the virtual device management unit 52. The virtual device management unit 52 changes the access location of the virtual device 50 to “NULL”. As a result, the cache data is released from the virtual machine 4.

When a request for keeping time is received from the cache management unit 53 and the device allocation management unit 51, the cache no-access timer 62 starts keeping time.

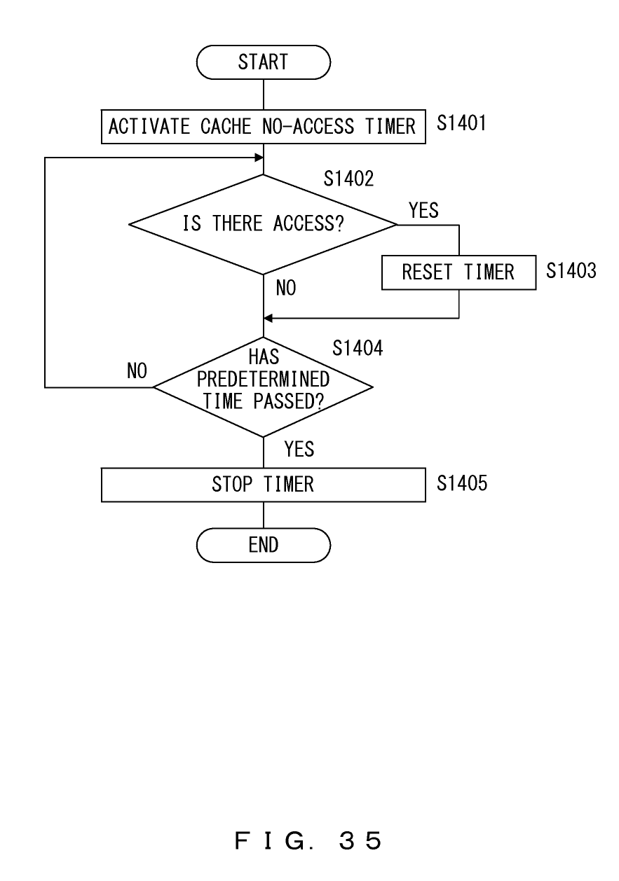

The information processing device 1 uses the resources above to execute the following process. FIG. 35 is a flow chart showing a procedure of a releasing process of cache data. When the recording medium 2 is attached to the external recording device 11, the cache operation unit 56 stores the data of the recording medium 2 in the cache storage unit 57 as cache data. The virtual machine monitor 5 changes the device state of the external storage device 11 to the release-enabled state.

The virtual machine monitor 5 activates the cache no-access timer 62 (S1401). The virtual machine monitor 5 checks whether there is an access to the cache data stored in the cache storage unit 57 (S1402).

When the virtual machine monitor 5 determines that there is an access to the cache data (YES in S1402), the virtual machine monitor 5 resets the timer of the cache no-access timer 62 (S1403). The virtual machine monitor 5 proceeds to step S1404.

Meanwhile, when the virtual machine monitor 5 determines that there is no access to the cache data (NO in S1402), the virtual machine monitor 5 proceeds to step S1404.

When the timer is reset (S1403), or when the virtual machine monitor 5 determines that there is no access to the cache data (NO in S1402), the virtual machine monitor 5 checks whether the time kept by the cache no-access timer 62 is beyond a predetermined time (S1404). When the virtual machine monitor 5 determines that the kept time is not beyond the predetermined time (NO in S1404), the virtual machine monitor 5 returns to step S1402 and repeats the process.

Meanwhile, when the virtual machine monitor 5 determines that the kept time is beyond the predetermined time (YES in S1404), the virtual machine monitor 5 terminates the cache no-access timer 62 (S1405). The virtual machine monitor 5 changes the access location of the virtual device 50 to “NULL”. The virtual machine monitor 5 checks the device state of the external storage device 11 and changes the device state to the allocation-enabled state if the device state indicates the release-enabled state. The virtual machine monitor 5 ends the process.

Other than the process above, the information processing device 1 executes the basic device allocation process, the unreflected data process, the basic control process when the recording medium 2 is attached, the basic reading/writing process for the recording medium 2, the basic device releasing process, and the control process when the recording medium 2 is detached. The procedures of the processes are the same as the procedures of the processes executed by the information processing device 1 in the first embodiment. Therefore, the same step numbers are provided to the corresponding procedures, and the description will not be repeated.

In this way, the information processing device 1 can automatically release the external storage device 11 from the virtual machine 4 allocated to the external storage device 11 when the cache no-access state is continuing for a predetermined time. As a result, the information processing device 1 can efficiently allocate the external storage device 11 to the allocation-waiting virtual machine 4. The fifth embodiment has been described.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. An information processing device that logically divides a physical resource to operate the physical resource as a plurality of virtual computers, the information processing device comprising:
a reader/writer capable of reading and writing data to and from a removable recording medium;
a detection unit to detect a use status of the reader/writer; and
an allocation unit to allocate the reader/writer to one of the virtual computers based on the use status detected by the detection unit, wherein
the allocated reader/writer is configured to read and write data to and from the recording medium in accordance with a request from a virtual computer allocated to the reader/writer.

2. The information processing device according to claim 1, wherein
the detection unit is configured to detect the use status of the reader/writer when the virtual computer requests the allocation.

3. The information processing device according to claim 1 or 2, further comprising
a release unit to release the allocated reader/writer from the virtual computer allocated to the reader/writer based on the use status detected by the detection unit.

4. The information processing device according to claim 3, the allocation means further comprising:
a creation unit to create a virtual resource by virtualizing the reader/writer provided with the recording medium; and
a unit to allocate the created virtual resource to the virtual computer allocated to the reader/writer, in place of the allocated reader/writer, wherein
the reader/writer is configured to enter a release-enabled state based on the allocation of the created virtual resource.

5. The information processing device according to claim 4, wherein
the creation unit is configured to store data of the attached recording medium as cache data and create, as the virtual resource, a resource capable of reading and writing the stored data.

6. The information processing device according to claim 5, wherein
the creation unit is configured to create, as the virtual resource, a resource capable of reading and writing already stored data without using the data of the attached recording medium.

7. The information processing device according to claim 6, wherein
when the already stored data is deleted, the creation unit is configured to copy the data and create, as the virtual resource, a resource capable of reading and writing the copied data.

8. The information processing device according to claim 3, wherein
when the virtual computer of the allocated location requests release of the allocated reader/writer, the reader/writer is configured to be released when the detection unit detects detachment of the recording medium from the reader/writer.

9. The information processing device according to claim 8, further comprising
an output unit to issue a notification for detaching the recording medium until the detection unit detects detachment of the recording medium from the reader/writer.

10. The information processing device according to claim 9, wherein
when there is writing of data to the recording medium, the output unit is configured to issue a notification until the detection unit detects completion of the writing of the data.

11. The information processing device according to claim 9, further comprising
a writing location determination unit to determine whether the recording medium attached to the reader/writer is a writing location of data, wherein
when the writing location determination unit determines that the attached recording medium is not the writing location of the data, the output unit is configured to issue a notification for attaching a recording medium that is the writing location of the data.

12. The information processing device according to claim 9, further comprising
a detection unit to detect whether writing to the recording medium attached to the reader/writer is possible, wherein
when the detection unit determines that the writing to the attached recording medium is impossible, the output unit is configured to issue a notification for detaching the attached recording medium.

13. The information processing device according to claim 3, wherein
the detection unit is configured to detect the use status of the reader/writer when another virtual computer different from the virtual computer of the allocated location requests allocation of the reader/writer,
the release unit is configured to release the allocated reader/writer from the virtual computer allocated to the reader/writer when the detection unit detects that the reader/writer is in the release-enabled state, and
the allocation unit is configured to allocate the released reader/writer to the other virtual computer.

14. An information processing method of logically dividing a physical resource to operate the physical resource as a plurality of virtual computers, the information processing method comprising:
detecting a use status of a reader/writer capable of reading and writing data to and from a removable recording medium;
allocating the reader/writer to one of the virtual computers based on the detected use status; and
reading and writing, by the allocated reader/writer, data to and from the recording medium in accordance with a request from a virtual computer allocated to the reader/writer.

15. A non-transitory computer-readable storage medium storing a computer program for causing a computer to logically divide a physical resource to operate the physical resource as a plurality of virtual computers, the computer program causing the computer to execute:
detecting a use status of a reader/writer capable of reading and writing data to and from a removable recording medium;
allocating the reader/writer to one of the virtual computers based on the detected use status; and
controlling the allocated reader/writer to read and write data to and from the recording medium in accordance with a request from a virtual computer allocated to the reader/writer.
